(19) United States
(12) Patent Application Publication
(10) Pub. No.: US 2026/0261112 A1
(43) Pub. Date: Sep. 3, 2026

(54) ELECTRONIC CONTROL UNIT

(71) Applicants: DENSO CORPORATION, Kariya-city (JP); DENSO ELECTRONICS CORPORATION, Anjo-city (JP)

(72) Inventors: Akimitsu INOUE, Kariya-city (JP); Jun FUKUHARA, Kariya-city (JP); Noriaki OKADA, Kariya-city (JP); Yoshifumi KISHIMOTO, Kariya-city (JP); Keisuke SANDA, Kariya-city (JP); Shigekazu SUGIMOTO, Anjo-city (JP); Akira SUGIURA, Anjo-city (JP); Naoyuki YASUDA, Anjo-city (JP)

(21) Appl. No.: 19/659,092

(22) Filed: Apr. 27, 2026

Related U.S. Application Data
(63) Continuation of application No. PCT/JP2024/032618, filed on Sep. 12, 2024.

(30) Foreign Application Priority Data
Oct. 31, 2023 (JP) 2023-186045

(51) Int. Cl. H02H 3/10; H02J 3/001

(52) U.S. Cl. CPC H02H 3/10; H02J 3/001

(57) ABSTRACT

An electronic control unit receives power from multiple supplies and distributes the power to loads. The electronic control unit has power terminals for the supplies, load terminals for the loads, and wiring with a main line between a first and second power terminal. Branch lines connect the main line to each load terminal. Disconnect circuits are installed on the main line and on each branch line, and can be switched between conducting (connected) and non-conducting (disconnected) states by a controller. The disconnect circuits include a main-line disconnect circuit, load disconnect circuits on the branch lines, and first and second power disconnect circuits on respective main-line sections. When the controller in the electronic control unit detects an abnormal condition based on current and/or voltage, the controller disconnects the main line and at least one terminal circuit to cut off power.

### CROSS REFERENCE TO RELATED APPLICATIONS

The present application is a continuation application of International Patent Application No. PCT/JP2024/032618 filed on September 12, 2024, which designated the U.S. and claims the benefit of priority from Japanese Patent Application No. 2023-186045 filed on October 31, 2023. The entire disclosures of all of the above applications are incorporated herein by reference.

### TECHNICAL FIELD

The disclosure in this specification relates to an electronic control unit.

### BACKGROUND

A power supply device may be an electronic control unit that has a power distribution function.

### SUMMARY

According to an aspect of the present disclosure, an electronic control unit receives power from power supplies and distribute the power to loads. The electronic control unit includes terminals, a power wiring, disconnect circuits, and a controller. The terminals include: power terminals that are electrically connected to the power supplies; and load terminals that are electrically connected to the loads. The power wiring includes: a main line that electrically connects a first power terminal to a second power terminal, the first power terminal being one of the power terminals, the second power terminal being another of the power terminals; and branch lines that electrically connect the main line to the load terminals. The disconnect circuits are respectively located at the main line and the branch lines. Each disconnect circuit conducts a current supplied from a respective one of the power supplies in a connection state, and cuts off current supplied from the respective one of the power supplies in a disconnection state. The controller controls each of the disconnect circuits to selectively switch between the connection state and the disconnection state. The main line includes: a first main-line section extending between the main-line disconnect circuit and the first power terminal; and a second main-line section extending between the main-line disconnect circuit and the second power terminal. The terminal disconnect circuits may include: load disconnect circuits correspondingly located at the branch lines, each branch line is connected to a corresponding one of the load terminals; a first power disconnect circuit located at a portion of the first main line that extends between the first power terminal and junction nodes at the branch lines are connected to the first main-line section; and a second power disconnect circuit located at a portion of the second main line section that extends between the second power terminal and junction nodes at which the branch lines are connected to the second main-line section. The controller may control the main-line disconnect circuit and at least one of the terminal disconnect circuits to the disconnection state, on condition that at least one of (i) a current flowing through the disconnect circuits or (ii) a voltage of the power wiring satisfies a predetermined abnormality detection condition.

### BRIEF DESCRIPTION OF DRAWINGS

FIG. 1 is a diagram showing the overall configuration of an ECU according to a first embodiment.

FIG. 2 is a diagram illustrating an example of a disconnect circuit.

FIG. 3 is a diagram illustrating another example of the disconnect circuit.

FIG. 4 is a diagram illustrating another example of the disconnect circuit.

FIG. 5 is a diagram illustrating another example of the disconnect circuit.

FIG. 6 is a diagram illustrating a control unit.

FIG. 7 is a diagram illustrating terminals of a microcontroller.

FIG. 8 is a diagram illustrating a threshold value.

FIG. 9 is a diagram illustrating the relationship between each latch detection and abnormal modes.

FIG. 10 is a flowchart illustrating INT_C interrupt processing.

FIG. 11 is a flowchart illustrating post-shutdown processing 1.

FIG. 12 is a flowchart illustrating A3/B3 output processing.

FIG. 13 is a flowchart illustrating INT_A1 interrupt processing.

FIG. 14 is a flowchart illustrating INT_A1H' interrupt processing.

FIG. 15 is a flowchart illustrating post-shutdown processing 2.

FIG. 16 is a flowchart illustrating INT_A1h interrupt processing.

FIG. 17 is a diagram illustrating an example of operation when a ground fault occurs at A3 terminal.

FIG. 18 is a diagram illustrating an operation when a ground fault occurs at the A3 terminal.

FIG. 19 is a diagram illustrating an example of operation when a cutoff circuit A3 fails to interrupt upon occurrence of a ground fault at the A3 terminal.

FIG. 20 is a diagram illustrating an example of operation when a ground fault occurs at an A1 terminal.

FIG. 21 is a diagram illustrating the operation when a ground fault occurs at the A1 terminal.

FIG. 22 is a diagram illustrating an example of operation when the disconnect circuit A1 fails to disconnect upon occurrence of a ground fault at the A1 terminal.

FIG. 23 is a diagram illustrating an example of operation when an open fault occurs at the A1 terminal.

FIG. 24 is a diagram illustrating the operation when an open fault occurs at the A1 terminal.

FIG. 25 is a diagram illustrating an example of operation during a momentary ground fault, due to off-delay.

FIG. 26 is a diagram illustrating the operation during a momentary ground fault due to off-delay.

FIG. 27 is a diagram illustrating the operation of the control unit during a momentary ground fault.

FIG. 28 is a diagram illustrating a modified example of the control unit.

FIG. 29 is a diagram illustrating the threshold value.

FIG. 30 is a diagram illustrating another example of the load.

FIG. 31 is a diagram illustrating a control unit in an ECU according to a second embodiment.

FIG. 32 is a diagram illustrating a control unit in an ECU according to a third embodiment.

FIG. 33 is a diagram illustrating a control unit in an ECU according to a fourth embodiment.

FIG. 34 is a diagram illustrating the threshold value.

FIG. 35 is a diagram illustrating a modified example.

FIG. 36 is a diagram illustrating a modified example.

FIG. 37 is a diagram illustrating a power supply system to which an ECU according to a fifth embodiment is adapted.

FIG. 38 is a diagram illustrating a control unit.

FIG. 39 is a diagram illustrating the threshold value.

FIG. 40 is a diagram illustrating disconnection conditions of the disconnect circuit.

FIG. 41 is a diagram illustrating an example of an operation when a ground fault occurs.

FIG. 42 is a diagram illustrating an example of an operation when a ground fault occurs.

### DETAILED DESCRIPTION

An electronic control unit may have two switches arranged on electric wires connecting two power supplies. A load may be electrically connected to the electric wire at a position between the two switches. For example, if a fault such as a ground fault occurs in the power supply line connecting the electronic control unit and the power supply, and the switch may have a fault (remains stuck in the ON state) at that time and thus power supply to the load may not be maintained. From the above-mentioned perspective, or from other perspectives not previously discussed, further improvements are required for the electronic control unit.

According to an aspect of the present disclosure, an electronic control unit receives power from power supplies and distribute the power to loads. The electronic control unit includes terminals, a power wiring, disconnect circuits, and a controller. The terminals include: power terminals that are electrically connected to the power supplies; and load terminals that are electrically connected to the loads. The power wiring includes: a main line that electrically connects a first power terminal to a second power terminal, the first power terminal being one of the power terminals, the second power terminal being another of the power terminals; and branch lines that electrically connect the main line to the load terminals. The disconnect circuits are respectively located at the main line and the branch lines. Each disconnect circuit conducts a current supplied from a respective one of the power supplies in a connection state, and cuts off current supplied from the respective one of the power supplies in a disconnection state. The controller controls each of the disconnect circuits to selectively switch between the connection state and the disconnection state. The main line includes: a first main-line section extending between the main-line disconnect circuit and the first power terminal; and a second main-line section extending between the main-line disconnect circuit and the second power terminal. The terminal disconnect circuits include: load disconnect circuits correspondingly located at the branch lines, each branch line is connected to a corresponding one of the load terminals; a first power disconnect circuit located at a portion of the first main line that extends between the first power terminal and junction nodes at which the branch lines are connected to the first main-line section; and a second power disconnect circuit located at a portion of the second main line section that extends between the second power terminal and junction nodes at which the branch lines are connected to the second main-line section. The controller controls the main-line disconnect circuit and at least one of the terminal disconnect circuits to the disconnection state, on condition that at least one of (i) a current flowing through at least one of the disconnect circuits or (ii) a voltage of the power wiring satisfies a predetermined abnormality detection condition.

According to the above-mentioned electronic control unit, even if the terminal disconnect circuits are in a state where the terminal disconnect circuits cannot be disconnected at the time an abnormality such as a ground fault occurs, it is possible to avoid a situation in which power supply to all loads becomes impossible by cutting off the main line disconnect circuit. In other words, it is possible to maintain power supply to some of the loads.

The following describes multiple embodiments based on the drawings. In each embodiment, corresponding components are designated by the same reference numerals, and redundant descriptions may be omitted. In cases where only a part of the configuration is described in each embodiment, the other portions of the configuration may be implemented using the configurations described in the previously explained embodiments. Furthermore, in the description of each embodiment, not only the explicitly stated combinations of configurations but also, unless there is a particular impediment to such combinations, configurations from multiple embodiments may be partially combined even if not expressly mentioned.

### First Embodiment

An electronic control unit (ECU) according to the present embodiment has a power distribution function (power supply distribution function). Hereinafter, the electronic control unit is also referred to as an ECU. The ECU is mounted, for example, on a moving object. The ECU receives power from multiple power supplies installed in the moving object and distributes power to multiple devices mounted on the moving object. The moving object may be, for example, a vehicle, an aircraft, a ship, construction machinery, or agricultural machinery. As one example, the ECU according to the present embodiment is mounted on a vehicle. The ECU is a power distribution ECU that consolidates power distribution functions in the vehicle. For example, a zone ECU may also serve as the power distribution ECU. The vehicle may be provided with a power distribution ECU separate from the zone ECU, or may be provided with a power distribution ECU in a configuration that does not include a zone ECU.

The zone ECU, together with the central ECU as an upper-level ECU, onboard devices, communication lines, and the like, forms the in-vehicle network system. The in-vehicle network system is a communication network based on zone architecture, enabling efficient data exchange between the central ECU, multiple zone ECUs, and numerous onboard devices. The zone ECU controls the onboard devices based on commands from the central ECU. The onboard devices may include ECUs subordinate to the zone ECU, actuators, and sensors. The zone ECU is arranged in a predetermined zone within the vehicle. The zone ECU has a power distribution function and supplies operating power to each onboard device. The zone ECU has a gateway function, enabling mutual communication between networks with different communication methods by converting and relaying data between them. At least one of the plurality of zone ECUs may also serve as the aforementioned power distribution ECU.

### ECU

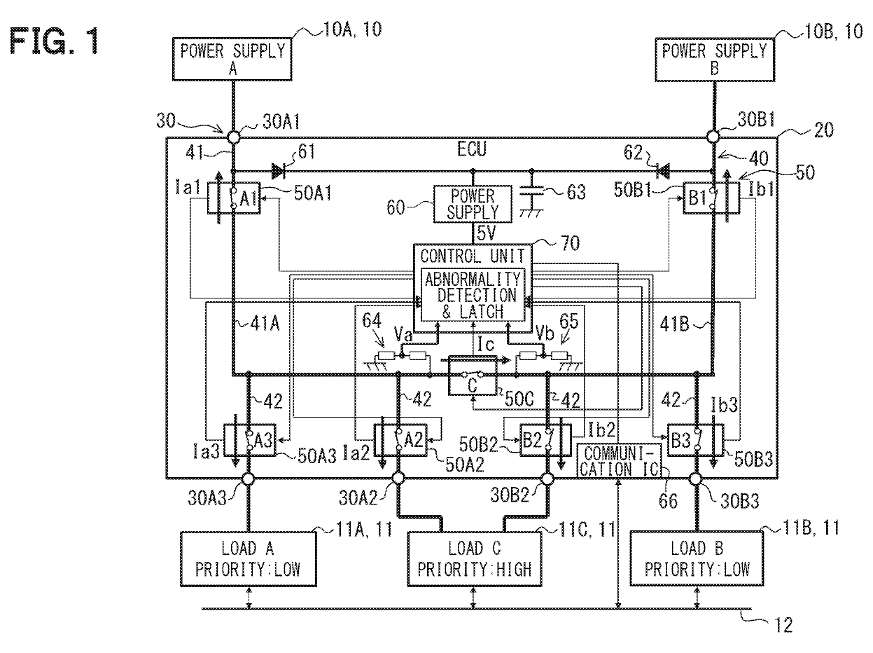

First, the overall configuration of the ECU will be described with reference to FIG. 1. As shown in FIG. 1, the ECU 20 receives power supply from power supplies 10 and distributes electric power to loads 11. The loads 11 correspond to the above-mentioned onboard devices or in-vehicle devices.

The power supplies 10 that supply electric power to the ECU 20 include at least a power supply 10A and a power supply 10B. For example, in the present embodiment, the power supply 10A (power supply A) is a main power supply, and the power supply 10B (power supply B) is an auxiliary power supply having a lower power supply capacity than the power supply 10A. The power supply 10A corresponds to a first power supply, and the power supply 10B corresponds to a second power supply. The power supply 10B, by itself, cannot supply electric power to all of the loads 11. The power supply 10A is, for example, a DC-DC converter that steps down and outputs electric power supplied from a main battery. The power supply 10B is, for example, an auxiliary battery.

The load 11 includes loads that are electrically connected to a main line 41A and loads that are electrically connected to a main line 41B, among the main lines 41. The “main line” described in the present disclosure may also be referred to as a main line. The load 11 may also include loads that are electrically connected to both the main line 41A and the main line 41B. For example, the load 11 in the present embodiment includes a load 11A, a load 11B, and a load 11C. The load 11A (load A) is electrically connected to the main line 41A via a corresponding branch line 42. The load 11B (load B) is electrically connected to the main line 41B via a corresponding branch line 42. The load 11C (load C) is electrically connected to each of the main lines 41A and 41B. The loads 11 can communicate with each other, for example, via a communication bus 12.

The load 11C has a higher priority for power supply by the ECU 20 than loads 11A and 11B. The loads 11A and 11B have a lower priority for power supply by the ECU 20 than the load 11C. The load 11C corresponds to the first load, and the loads 11A and 11B correspond to the second load. The priority of power supply among the loads 11 is preset. The priority is set, for example, according to the importance of the function. The loads 11 with functions important for driving, such as safety-related functions, may be designated as high-priority loads, while the loads 11 with other functions (normal functions), that is, non-safety-related functions, may be designated as low-priority loads. The loads 11 with a redundant configuration may be designated as high-priority loads, while the loads 11 with a non-redundant configuration may be designated as low-priority loads. In a vehicle, devices such as the EPS (Electric Power Steering) system and the brake system are provided redundantly.

For example, the load 11C in the present embodiment is an ECU having a safety-related function. The load 11C is a load with a redundant configuration. The load 11C is, for example, an ECU with a redundant configuration corresponding to a motor provided redundantly in an EPS device.

The ECU 20 includes terminals 30, power supply wiring 40, disconnect circuits 50, a power supply circuit 60, and a control unit 70. The power supply wiring 40 may also be referred to as a power wiring.

The terminals 30 are external connection terminals for electrically connecting the ECU 20 to external devices. For example, the terminals 30 in this embodiment include a terminal 30A1, a terminal 30A2, a terminal 30A3, a terminal 30B1, a terminal 30B2, and a terminal 30B3. The terminals 30A1 and 30B1 are so-called power supply terminals or power terminals. The terminal 30A1 (A1 terminal) is electrically connected to the power supply 10A via a power supply line. The terminal 30B1 (B1 terminal) is electrically connected to the power supply 10B via a power supply line. The terminal 30A1 corresponds to the first power supply terminal, and the terminal 30B1 corresponds to the second power supply terminal. For example, the terminals 30A1 and 30B1 of the present embodiment are connected to the corresponding power supplies 10A and 10B without passing through other devices (for example, an ECU).

The terminals 30A2, 30A3, 30B2, and 30B3 are load terminals for outputting electric power from the ECU 20 to the corresponding loads 11. Each of the terminals 30A2 and 30B2 is electrically connected to load 11C via the corresponding power supply line. The terminal 30A2 (A2 terminal) is connected via a power supply line corresponding to one of the redundant configurations of the load 11C, and the terminal 30B2 (B2 terminal) is connected via a power supply line corresponding to another of the redundant configurations of load 11C. The terminal 30A3 (A3 terminal) is electrically connected to the load 11A via the corresponding power supply line. The terminal 30B3 (B3 terminal) is electrically connected to the load 11B via the corresponding power supply line.

The terminals 30 are mounted on a printed circuit board, for example, as connectors. The terminals 30 may be consolidated into a single connector, or may be distributed among connectors. As described above, since the load 11C has a redundant configuration, the corresponding terminals 30A2 and 30B2 are also configured redundantly. For example, the number of terminals (pins) of 30A2 and 30B2 is equal, and their structures are also approximately the same.

The power supply wiring 40 electrically connects the terminals 30 to each other. The power supply wiring 40 provides a power network. The power supply wiring 40 includes a main line 41 and a plurality of branch lines 42. The main line 41 electrically connects the power supply terminals to each other. The main line 41 is a power supply wiring that connects the terminal 30A1 and the terminal 30B1. The main line 41 forms the main framework of the power network. The main line 41 may also be referred to as a backbone or the like.

The main line 41 includes main lines 41A and 41B. The main line 41A (main line A) is the portion of the main line 41 that extends from the terminal 30A1 to a disconnect circuit 50C. The main line 41B (main line B) is the portion extending from the terminal 30B1 to the disconnect circuit 50C. The main line 41A is the portion of the main line 41 on the terminal 30A1 side, and the main line 41B is the portion of the main line 41 on the terminal 30B1 side. The main line 41A corresponds to the first main line, and the main line 41B corresponds to the second main line.

The branch line 42 electrically connects each load terminal to the main line 41. The branch line 42 individually connects the load terminals to the main line 41. The power supply wiring 40 includes the branch line 42 connected to main line 41A and the branch line 42 connected to main line 41B. For example, the power supply wiring 40 according to the present embodiment includes two branch lines 42 connected to the main line 41A and two branch lines 42 connected to main line 41B. One of the branch lines 42 connected to main line 41A is connected to the terminal 30A2, and the other is connected to the terminal 30A3. One of the branch lines 42 connected to main line 41B is connected to the terminal 30B2, and the other is connected to the terminal 30B3.

The power supply wiring 40 include, for example, wiring formed on a printed circuit board. The power supply wiring 40 may also include the above-mentioned wiring and wiring members such as metal plate materials mounted on the printed circuit board.

The disconnect circuit 50 is provided on the power supply wiring 40 and switches the current flowing through the power supply wiring 40 on and off. The disconnect circuit 50 disconnects the power supply 10 electrically. The disconnect circuit 50 is provided on each of the main line 41 and the branch line 42. For example, the disconnect circuit 50 according to the present embodiment includes disconnect circuits 50A1, 50A2, 50A3, 50B1, 50B2, 50B3, and 50C.

The disconnect circuit 50C (disconnect circuit C) is provided on the main line 41. The disconnect circuit 50C corresponds to a main-line disconnect circuit. The main line 41A is connected to the disconnect circuit 50C. The main line 41B is connected to the disconnect circuit 50C. In the disconnection (off) state, the disconnect circuit 50C electrically separates the main line 41A from the main line 41B. The disconnection state described in the present disclosure may also be referred to as a cut-off state or an interruption state. In the non-disconnection (on) state, the disconnect circuit 50C electrically connects the main line 41A to the main line 41B. The disconnect circuit 50C may also be referred to as an isolator or backbone switch.

The disconnect circuits 50A1, 50A2, 50A3, 50B1, 50B2, and 50B3 are provided corresponding to the terminals 30. The disconnect circuits 50A1, 50A2, 50A3, 50B1, 50B2, and 50B3 correspond to terminal disconnect circuits. The disconnect circuits 50A1, 50A2, 50A3, 50B1, 50B2, and 50B3 connect or disconnect the corresponding terminals 30 and the power supply wiring 40.

The disconnect circuit 50A1 (disconnect circuit A1) is provided on the main line 41A in the vicinity of the terminal 30A1. The disconnect circuit 50A1 corresponds to a first power disconnect circuit. The disconnect circuit 50A1 is provided on the main line 41A between the connection position of the branch line 42 and the terminal 30A1. In other words, the branch line 42 is connected to the main line 41A between the disconnect circuit 50A1 and the disconnect circuit 50C. In the disconnection state, the disconnect circuit 50A1 electrically isolates the portion of the main line 41 on the side of the disconnect circuit 50C from the disconnect circuit 50A1, and the terminal 30A1 (power supply 10A).

The disconnect circuit 50B1 (disconnect circuit B1) is provided in the vicinity of the terminal 30B1 on the main line 41B. The disconnect circuit 50B1 corresponds to a second power disconnect circuit. The disconnect circuit 50B1 is provided on the main line 41B between the connection position of the branch line 42 and the terminal 30B1. In other words, the branch line 42 is connected to the main line 41B between the disconnect circuit 50B1 and the disconnect circuit 50C. In the disconnection state, the disconnect circuit 50B1 electrically isolates the portion of the main line 41 that is on the disconnect circuit 50C side relative to the disconnect circuit 50B1 from the terminal 30B1 (power supply 10B).

The disconnect circuits 50A2, 50A3, 50B2, and 50B3 correspond to load disconnect circuits. The disconnect circuit 50A2 (disconnect circuit A2) is provided on the branch line 42 that connects the main line 41A to the terminal 30A2. The disconnect circuit 50A2 is provided in the corresponding branch line 42 in the vicinity of the terminal 30A2. In the disconnection state, the disconnect circuit 50A2 electrically isolates terminal 30A2 from main line 41A. The disconnect circuit 50B2 (disconnect circuit B2) is provided on the branch line 42 that connects the main line 41B to the terminal 30B2. The disconnect circuit 50B2 is provided in the corresponding branch line 42 in the vicinity of the terminal 30B2. In the disconnection state, the disconnect circuit 50B2 electrically isolates the terminal 30B2 from the main line 41B. For example, the disconnect circuit 50A2, in the disconnection state, electrically isolates one of the redundant configurations of the load 11C from the main line 41A. In the disconnection state, the disconnect circuit 50B2 electrically isolates another one of the redundant configurations of the load 11C from the main line 41B.

The disconnect circuit 50A3 (disconnect circuit A3) is provided in the branch line 42 that connects the main line 41A to the terminal 30A3. The disconnect circuit 50A3 is provided in the corresponding branch line 42 in the vicinity of the terminal 30A3. In the disconnection state, the disconnect circuit 50A3 electrically isolates the terminal 30A3 from the main line 41A. The disconnect circuit 50B3 (disconnect circuit B3) is provided in the branch line 42 that connects the main line 41B to the terminal 30B3. The disconnect circuit 50B3 is provided in the corresponding branch line 42 in the vicinity of the terminal 30B3. In the disconnection state, the disconnect circuit 50B3 electrically isolates the terminal 30B3 from the main line 41B.

The disconnect circuit 50 includes electronic components mounted on, for example, a printed circuit board. The disconnect circuit 50 includes a switch, a drive unit (drive circuit) for driving the switch, and a current detection unit. Hereinafter, the direction in which the current flowing through each disconnect circuit 50 flows toward the nearby terminal 30 is defined as the positive direction, and the direction flowing away from the terminal 30 is defined as the negative direction. The directions indicated by the solid arrows in FIG. 1 all represent the positive direction. The following describes the configuration of the disconnect circuit 50. The terminal 30 described in the present disclosure may also be referred to as a terminal block.

The power supply circuit 60 is an internal power supply circuit provided within the ECU 20. The power supply circuit 60 generates a constant voltage lower than the supply voltage based on the voltage supplied from the power supply 10. The power supply circuit 60 generates the operating voltage for the control unit 70 (for example, 5V) and outputs it to the control unit 70. In addition to the power supply circuit 60, the ECU 20 is provided with diodes 61 and 62, a capacitor 63, voltage divider circuits 64 and 65, and a communication IC 66. The power supply circuit 60, the diodes 61 and 62, the capacitor 63, the voltage divider circuits 64 and 65, and the communication IC 66 include electronic components mounted on, for example, a printed circuit board. In addition to the electronic components, wiring of the printed circuit board may also be included.

The diodes 61 and 62 are disposed in the wiring that electrically connects the power supply 10 and the power supply circuit 60 in order to prevent reverse current flow. The diodes 61 and 62 are arranged so that their anodes are on the power supply 10 side. The anode of diode 61 is connected to the main line 41A between the terminal 30A1 and the disconnect circuit 50A1. The anode of diode 62 is connected to the main line 41B between the terminal 30B1 and the disconnect circuit 50B1.

The capacitor 63 is connected to the wiring that electrically connects the power supply 10 to the power supply circuit 60. The capacitor 63 is connected to the wiring at a position between the cathodes of diodes 61 and 62. The positive electrode of the capacitor 63 is connected to the wiring, and the negative electrode of the capacitor 63 is grounded.

The voltage divider circuit 64 is a circuit for detecting the voltage of the main line 41A. The voltage divider circuit 65 is a circuit for detecting the voltage of the main line 41B. The control unit 70 monitors the voltage Va, which is resistively divided by the voltage divider circuit 64, and the voltage Vb, which is resistively divided by the voltage divider circuit 65. The communication IC 66 is a circuit that allows the ECU 20 (control unit 70) to communicate with other devices, such as other ECUs, via the communication bus 12.

The control unit 70 controls the disconnect circuit 50. The control unit 70 controls the operation (on/off) of the switch included in the disconnect circuit 50. The control unit 70 acquires the aforementioned voltages Va and Vb, and controls the disconnect circuit 50 based on the voltages Va and Vb. The control unit 70 acquires the current detected by the disconnect circuit 50 and controls the disconnect circuit 50 based on the current. As shown in FIG. 1, the control unit 70 acquires the current Ia1 from the disconnect circuit 50A1 and acquires the current Ib1 from the disconnect circuit 50B1. The control unit 70 acquires the current Ia2 from the disconnect circuit 50A2 and acquires the current Ib2 from the disconnect circuit 50B2. The control unit 70 acquires the current Ia3 from the disconnect circuit 50A3 and acquires the current Ib3 from the disconnect circuit 50B3.

The control unit 70 includes, for example, electronic components mounted on a printed circuit board and wiring formed on the printed circuit board. In addition to its function of detecting abnormalities based on voltage and current, the control unit 70 also has a latch function for retaining abnormality detection data. The following describes the configuration of the control unit 70.

### Disconnect Circuit

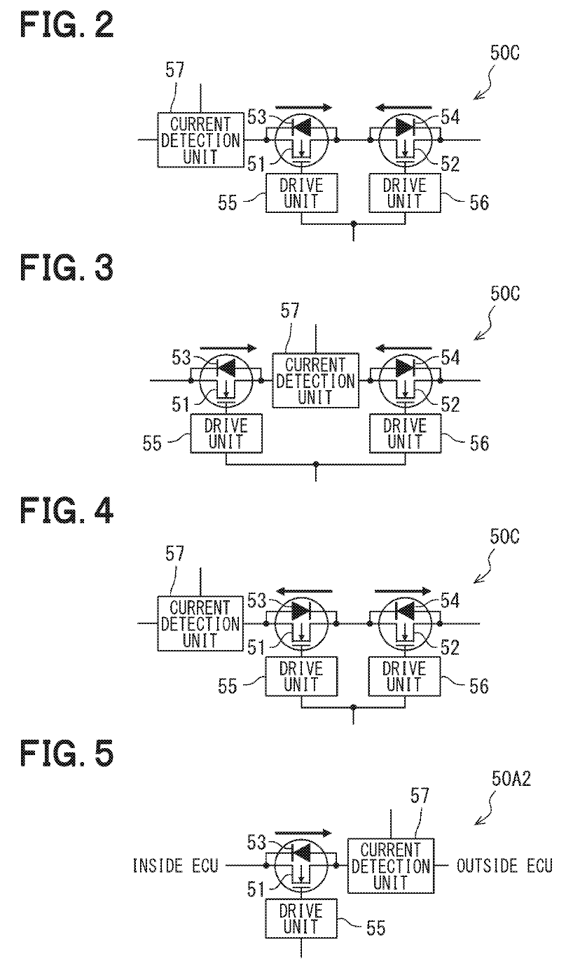

The following describes the configuration of the disconnect circuit with reference to FIGS. 2 to 5. FIG. 2 shows an example of the disconnect circuit. FIG. 3 shows another example of the disconnect circuit. FIG. 4 shows another example of the disconnect circuit. FIG. 5 shows another example of the disconnect circuit. In FIGS. 2 to 5, the solid arrows represent the direction of current flow that each MOSFET is capable of disconnecting.

The disconnect circuit 50C can employ, for example, any one of the configurations shown in FIG. 2, FIG. 3, or FIG. 4. The disconnect circuit 50A1 can employ, for example, any one of the configurations shown in FIG. 2, FIG. 3, FIG. 4, or FIG. 5. The remaining disconnect circuits 50A2, 50A3, 50B1, 50B2, and 50B3 can employ, for example, the configuration shown in FIG. 5. In FIGS. 2 to 4, the disconnect circuit 50C is shown as an example. In FIG. 5, the disconnect circuit 50A2 is shown as an example.

The disconnect circuit 50C shown in FIG. 2 includes n-channel MOSFETs 51 and 52, diodes 53 and 54, drive units 55 and 56, and a current detection unit 57. MOSFET is an abbreviation for Metal Oxide Semiconductor Field Effect Transistor. The MOSFETs 51 and 52 correspond to the switches described above. The disconnect circuit 50C is a source-common type disconnect circuit in which the sources of the two MOSFETs 51 and 52 are commonly connected. The diodes 53 and 54 are parasitic diodes of the corresponding MOSFETs 51 and 52. The diode 53 is connected in reverse parallel with the corresponding MOSFET 51. The diode 54 is connected in reverse parallel with the corresponding MOSFET 52. The anodes of diodes 53 and 54 are connected to the sources of the corresponding MOSFETs 51 and 52, and the cathodes are connected to the drains.

The drive units 55 and 56 may also be referred to as drivers. A common control signal (gate drive signal) is provided to the drive units 55 and 56. When an OFF signal (L level) is provided, the drive units 55 and 56 turn off the MOSFETs 51 and 52. The current detection unit 57 is disposed outside the series circuit formed by the MOSFETs 51 and 52. The current detection unit 57 may include, for example, a shunt resistor to obtain a voltage value corresponding to the current.

Because the diodes 53 and 54 are arranged in the reverse direction, turning off both MOSFETs 51 and 52 can prevent bidirectional current flow. The diode 53 can block current flowing from the drain to the source of MOSFET 51, that is, in the direction from MOSFET 51 to MOSFET 52. The diode 54 can block current flowing from the drain to the source of MOSFET 52, that is, in the direction from MOSFET 52 to MOSFET 51. On the other hand, when an ON signal (H-level signal) is input, the disconnect circuit 50C enters a conductive state, allowing current to flow in both directions—that is, current flowing from MOSFET 51 to MOSFET 52 and current flowing from MOSFET 52 to MOSFET 51. In this manner, it is possible to either conduct or block bidirectional current.

As shown in FIG. 3, the current detection unit 57 may be provided between the MOSFET 51 and MOSFET 52. The current detection unit 57 is provided between the source of MOSFET 51 and the source of MOSFET 52. The other configurations are the same as those shown in the example of FIG. 2. With the configuration shown in FIG. 3 as well, it is possible to either conduct or block bidirectional current.

As shown in FIG. 4, a drain-common type disconnect circuit may also be used. The drains of the MOSFETs 51 and 52 are connected in common. The other configurations are the same as those in the example of FIG. 2. In this configuration, the diodes 53 and 54 are also oriented in the reverse direction. Therefore, by turning off both MOSFETs 51 and 52, it is possible to prevent bidirectional current flow. Additionally, by turning on both MOSFETs 51 and 52, bidirectional current can be conducted. Although not illustrated, in the configuration shown in FIG. 4, the current detection unit 57 may be provided between the drains of MOSFETs 51 and 52.

The disconnect circuit 50A2 shown in FIG. 5 includes the MOSFET 51, the diode 53, the drive unit 55, and the current detection unit 57. As in the configuration described above, the diode 53 is connected in reverse parallel to the MOSFET 51. The anode of the diode 53 is connected to the source of the MOSFET 51, and the cathode is connected to the drain. The MOSFET 51 is arranged such that its drain is on the internal side of the ECU 20, and its source is on the external side of the ECU 20. The current detection unit 57 is connected to the source of the MOSFET 51.

The disconnect circuit 50A2 blocks the current flowing from the drain to the source of the MOSFET 51, that is, in the direction from the internal side to the external side of the ECU 20, by turning off the MOSFET 51. By turning off the MOSFET 51, it is possible to block the current flowing from the disconnect circuit 50 toward the corresponding terminal 30.

Alternatively, as the switch in the disconnect circuit 50, a switch without a parasitic diode, such as an IGBT (Insulated Gate Bipolar Transistor) or a normally-on switch, may be used in place of a switch with a parasitic diode. When a switch without a parasitic diode is used, for example, the disconnect circuit 50C can be configured with a single switch.

### Control Unit

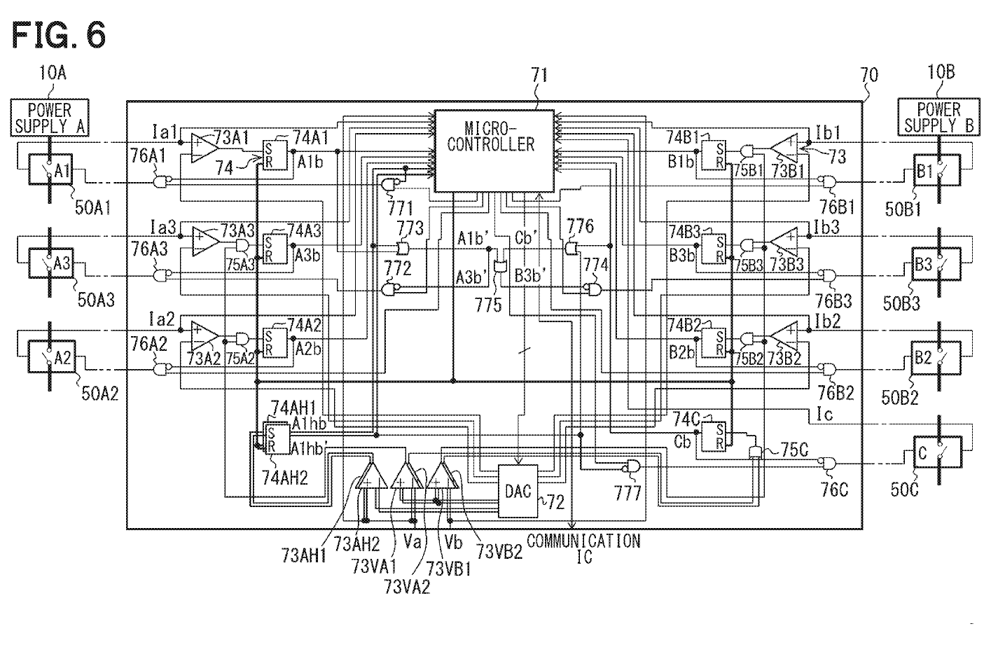

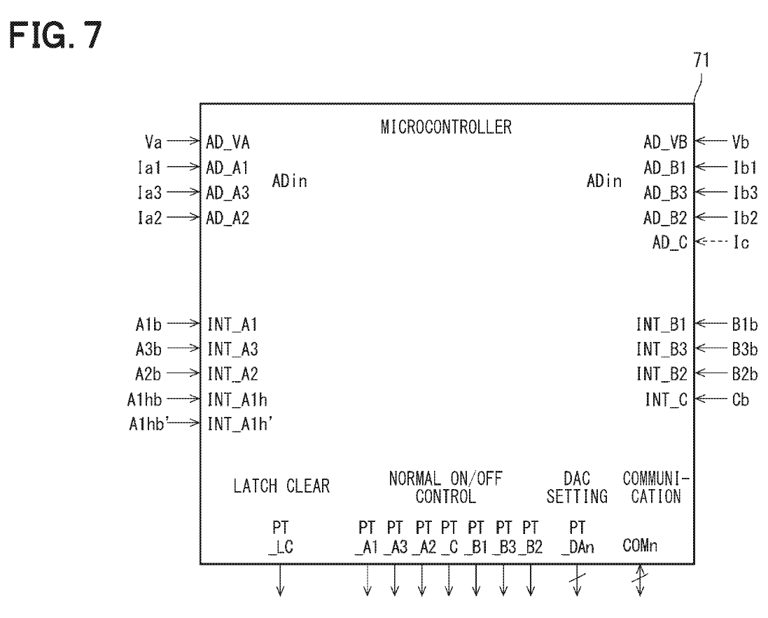

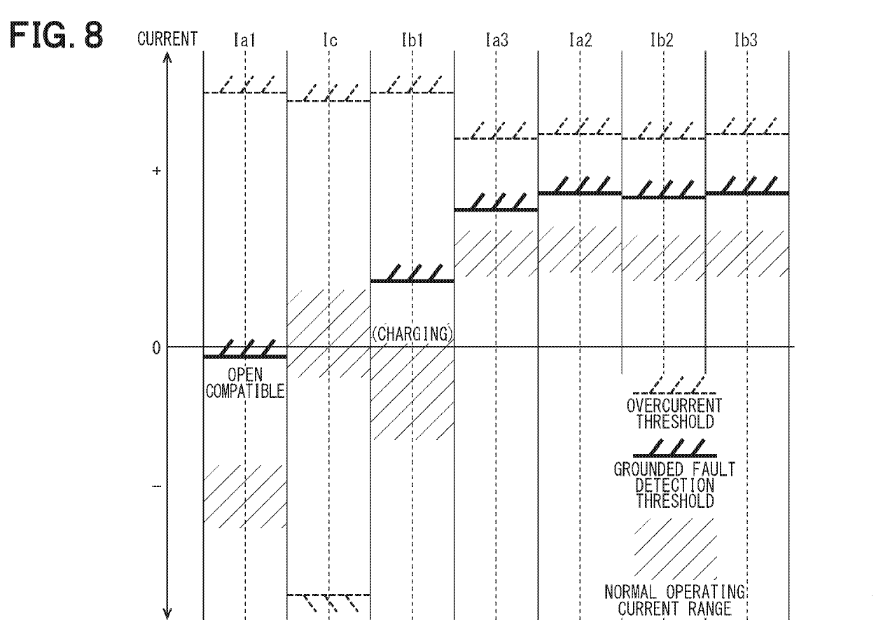

The following describes the configuration of the control unit 70 with reference to FIGS. 6 to 8. FIG. 6 shows the control unit 70. FIG. 7 shows the terminals of the microcontroller 71. FIG. 8 shows a threshold value.

The control unit 70 includes a processing circuit that includes a processor, memory, storage, and other components. The processor performs various processes to realize each function by accessing the memory. The memory is, for example, RAM (Random Access Memory). RAM is an abbreviation for Random Access Memory. The storage includes non-volatile storage media such as flash memory. The storage stores a control program executed by the processor. The execution of the control program by the processor corresponds to the execution of a control method associated with the control program.

For example, the control unit 70 according to the present embodiment includes a microcontroller 71, a DAC (Digital to Analog Converter) 72, comparators 73, latches 74, and gate circuits (logic gates). DAC is an abbreviation for Digital to Analog Converter.

The microcontroller 71 includes, for example, a CPU (Central Processing Unit), RAM, ROM (Read Only Memory), and an A/D converter. CPU is an abbreviation for Central Processing Unit. ROM is an abbreviation for Read Only Memory. As shown in FIG. 7, the microcontroller 71 has multiple terminals. The terminals include an ADin terminal, an INT terminal, a PT terminal, and COMn terminals.

The ADin terminal receives the aforementioned voltages Va and Vb, and currents Ia1, Ia2, Ia3, Ib1, Ib2, Ib3, and Ic. The ADin terminal is a terminal for monitoring voltage and current. The INT terminal receives the value output from the latch 74. The INT terminal is an interrupt request terminal. The PT terminal includes a terminal that outputs a control signal for the switch (MOSFET) forming the disconnect circuit 50. The PT terminal includes a terminal that outputs a signal for clearing the latch 74 and a terminal for setting the DAC 72. The communication terminal COMn is an input/output terminal for communicating with external devices via the above-mentioned communication IC 66.

The DAC 72 converts the setting value output from the microcontroller 71 from digital to analog and outputs the converted value to each comparator 73 as a threshold value. The comparator 73 compares the detected value of voltage or current with the threshold value and outputs the comparison result. The comparator 73 detects abnormalities such as ground faults or overvoltage. The comparator 73 includes comparators 73A1, 73A2, 73A3, 73B1, 73B2, and 73B3. These comparators 73A1, 73A2, 73A3, 73B1, 73B2, and 73B3 detect, for example, ground faults based on the current flowing through the disconnect circuit 50.

The comparator 73A1 outputs the comparison result between the current Ia1 and the threshold value. The comparator 73A2 outputs the comparison result between the current Ia2 and the threshold value. The comparator 73A3 outputs the comparison result between the current Ia3 and the threshold value. The comparator 73B1 outputs the comparison result between the current Ib1 and the threshold value. The comparator 73B2 outputs the comparison result between the current Ib2 and the threshold value. The comparator 73B3 outputs the comparison result between the current Ib3 and the threshold value. In the example shown in FIG. 6, the threshold value is provided to the inverting input terminals of the comparators 73A1, 73A2, 73A3, 73B1, 73B2, and 73B3, while the current value is provided to their non-inverting input terminals.

FIG. 8 shows an example of a set threshold value. FIG. 8 shows the threshold value for ground fault detection, the overcurrent threshold value, and the operating current range during normal operation. The value detected by the current detection unit 57 indicates a positive (+) value when current is flowing in the forward direction, and a negative (−) value when current is flowing in the reverse direction. The ground fault detection threshold is set between the overcurrent threshold and the operating current range during normal operation. As will be described later, the ground fault refers to a ground fault occurring outside the terminal 30 or at the terminal 30. The outside of terminal 30 refers to, for example, the power supply line connecting the terminal 30 to the power supply 10, or the power supply line connecting the terminal 30 to the load 11. In the following description, a ground fault occurring outside terminal 30 may also be referred to as a ground fault of terminal 30.

For example, in this embodiment, the ground fault detection threshold for the current Ia1 is set so that open-circuit detection is also possible. In other words, a threshold value that serves both for open-circuit and ground fault detection is set. Since the current Ia1 flowing during an open circuit is nearly zero (0), a negative value close to zero is set. In this embodiment, the power supply capability of the power supply 10B is lower than that of the power supply 10A, and it is possible for the power supply 10B to be charged by the power supplied from the power supply 10A. An open at the terminal 30A1 refers, for example, to an open circuit that occurs in the power supply line connecting the terminal 30A1 to the power supply 10A.

The comparator 73 further includes comparators 73AH1, 73AH2, 73VA1, 73VA2, 73VB1,and 73VB2. The comparators 73AH1 and 73AH2 detect abnormalities (overvoltage) in the voltage supplied from the power supply 10A, which has a high power supply capability. Both comparators 73AH1 and 73AH2 receive the voltage Va as their input. The threshold value set for the comparator 73AH2 is higher than the threshold value set for the comparator 73AH1. As a result, the comparator 73AH2 outputs an H-level signal indicating an abnormality later than the comparator 73AH1. Therefore, the timing of the latch is also delayed. In the example shown in FIG. 6, the threshold values are provided to the inverting input terminals of comparators 73AH1 and 73AH2, and the voltage values are provided to the non-inverting input terminals.

The comparators 73VA1 and 73VA2 detect, for example, a drop in voltage Va due to a ground fault. Both the comparators 73VA1 and 73VA2 receive the voltage Va as an input. The threshold value set for the comparator 73VA2 is lower than the threshold value set for the comparator 73VA1. As a result, the comparator 73VA2 outputs an H-level signal indicating an abnormality later than the comparator 73VA1. Similarly, the comparators 73VB1 and 73VB2 detect a drop in voltage Vb. Both the comparators 73VB1 and 73VB2 receive the voltage Vb as an input. The threshold value set for the comparator 73VB2 is lower than the threshold value set for the comparator 73VB1. As a result, the comparator 73VB2 outputs an H-level signal indicating an abnormality later than the comparator 73VB1.

In the example shown in FIG. 6, the threshold values are provided to the non-inverting terminals of the comparators 73VA1, 73VA2, 73VB1, and 73VB2, while the voltage values are provided to their inverting terminals. In this embodiment, for example, the threshold values of the comparators VA1 and VB1 are set to a common value (an equal value). The threshold values of the comparators VA2 and VB2 are set to a common value.

The latch 74 holds the data. In this embodiment, for example, the latch 74 is an SR latch. The R terminal of each latch 74 is electrically connected to a PT terminal (PT_LC) that outputs a signal for clearing the data in the latch 74. The latch 74 includes latches 74A1, 74A2, 74A3, 74B1, 74B2, 74B3, and 74C.

Since open detection is also performed, the S terminal of the latch 74A1 receives the output signal from the corresponding comparator 73A1. The S terminal of the latch 74A2 receives the output signal from the corresponding gate circuit 75A2. The gate circuit 75A2 is an AND gate, and its input terminals receive the output signals from the comparator 73A2 and the comparator 73VA1. Similarly, the S terminal of the latch 74A3 receives the output signal from the corresponding gate circuit 75A3. The gate circuit 75A3 is an AND gate, and its input terminals receive the output signals from the comparator 73A3 and the comparator 73VA1.

The S terminal of the latch 74B1 receives the output signal from the corresponding gate circuit 75B1. The gate circuit 75B1 is an AND gate, and its input terminals receive the output signals from the comparator 73B1 and the comparator 73VB1. Similarly, the S terminal of the latch 74B2 receives the output signal from the corresponding gate circuit 75B2. The gate circuit 75B2 is an AND gate, and its input terminals receive the output signals from the comparator 73B2 and the comparator 73VB1. The S terminal of the latch 74B3 receives the output signal from the corresponding gate circuit 75B3. The gate circuit 75B3 is an AND gate, and its input terminals receive the output signals from the comparator 73B3 and the comparator 73VB1.

The latch 74 further includes latches 74AH1 and 74AH2. The S terminal of the latch 74AH1 receives the output signal from the corresponding comparator 73AH1. Similarly, the S terminal of the latch 74AH2 receives the output signal from the corresponding comparator 73AH2.

The latch 74A1 outputs the A1b signal. The latch 74A2 outputs the A2b signal. The latch 74A3 outputs the A3b signal. The latch 74B1 outputs the B1b signal. The latch 74B2 outputs the B2b signal. The latch 74B3 outputs the B3b signal. The latch 74AH1 outputs the A1hb signal. The latch 74AH2 outputs the A1hb’ signal. Each of the signals described above is provided to the corresponding INT terminal of the microcontroller 71.

The gate circuit further includes gate circuits 76A1, 76A2, 76A3, 76B1, 76B2, 76B3, and 76C. The gate circuits 76A1, 76A2, 76A3, 76B1, 76B2, 76B3, and 76C are AND gates, with a NOT gate connected to one of their input terminals. The output signals of the gate circuits 76A1, 76A2, 76A3, 76B1, 76B2, 76B3, and 76C are provided to the drive units of the corresponding disconnect circuits 50.

The gate circuit 76A1 receives, as inputs, the inverted A1b signal and the output signal of gate circuit 771. The gate circuit 771 is also an AND gate, with a NOT gate connected to one of its input terminals. The gate circuit 771 receives, as inputs, the control signal for disconnect circuit 50A1 output from microcontroller 71, and the inverted A1hb signal. When at least one of the following conditions is satisfied: the control signal is at L level, the A1b signal is at H level, or the A1hb signal is at H level, the gate circuit 76A1 outputs an OFF signal (an L level signal) to the disconnect circuit 50A1 (switch) to set the disconnect circuit 50A1 to the disconnection state. For example, if the A1b signal becomes H level due to a ground fault or an open circuit, the gate circuit 76A1 outputs an OFF signal to the disconnect circuit 50A1. If the A1hb signal becomes H level due to overvoltage, the gate circuit 76A1 outputs an OFF signal to the disconnect circuit 50A1.

The gate circuit 76A2 receives, as inputs, the inverted A2b signal and the control signal for the disconnect circuit 50A2 output from the microcontroller 71. When the control signal is at L level and/or the A2b signal is at H level, the gate circuit 76A2 outputs an OFF signal to the disconnect circuit 50A2. For example, if the A2b signal becomes H level due to a ground fault, the gate circuit 76A2 outputs an OFF signal to the disconnect circuit 50A2.

The gate circuit 76A3 receives, as inputs, the inverted A3b signal and the output signal from the gate circuit 772. The gate circuit 772 is an AND gate, with a NOT gate connected to one of its input terminals. The gate circuit 772 receives, as inputs, the control signal for the disconnect circuit 50A3 output from the microcontroller 71 and the inverted A3b’ signal. The A3b’ signal is the A1b’ signal output from the gate circuit 773. The gate circuit 773 is an OR gate, and receives the A1b signal and the A1hb signal as inputs. When at least one of the following conditions is satisfied: the control signal is at L level, the A3b signal is at H level, the A1b signal is at H level, or the A1hb signal is at H level, the gate circuit 76A3 outputs an OFF signal to the disconnect circuit 50A3.

For example, if the A3b signal goes to H level due to a ground fault, the gate circuit 76A3 outputs an OFF signal to the disconnect circuit 50A3. When the A1hb signal goes to H level due to overvoltage, the gate circuit 76A3 outputs an OFF signal to the disconnect circuit 50A3. When the A1b signal goes to H level due to a ground fault or an open circuit, the gate circuit 76A3 outputs an OFF signal to the disconnect circuit 50A3.

The gate circuit 76B1 receives, as inputs, the signal obtained by inverting the B1b signal and the control signal for the disconnect circuit 50B1 output from the microcontroller 71. When the control signal is at L level and/or the B1b signal is at H level, the gate circuit 76B1 outputs an OFF signal to the disconnect circuit 50B1. Therefore, for example, when the B1b signal goes to H level due to a ground fault, the gate circuit 76B1 outputs an OFF signal to the disconnect circuit 50B1. Similarly, the gate circuit 76B2 receives, as inputs, the signal obtained by inverting the B2b signal and the control signal for the disconnect circuit 50B2 output from the microcontroller 71. When the control signal is at L level and/or the B2b signal is at H level, the gate circuit 76B2 outputs an OFF signal to the disconnect circuit 50B2. For example, when the B2b signal goes to H level due to a ground fault, the gate circuit 76B2 outputs an OFF signal to the disconnect circuit 50B2.

The gate circuit 76B3 receives, as inputs, the signal obtained by inverting the B3b signal and the output signal from the gate circuit 774. The gate circuit 774 is an AND gate, with a NOT gate connected to one of its input terminals. The gate circuit 774 receives, as inputs, the control signal for the disconnect circuit 50B3 output from the microcontroller 71 and the signal obtained by inverting the B3b' signal. The B3b’ signal is the output signal of the gate circuit 775. The gate circuit 775 is an OR gate, and the gate circuit 775 receives the A1b’ signal and the Cb’ signal as inputs. The Cb’ signal is the output signal of the gate circuit 776. The gate circuit 776 is an OR gate, and the gate circuit 776 receives the Cb signal and the A1hb’ signal as inputs. When at least one of the following conditions is satisfied: the control signal is at L level, the B3b signal is at H level, the Cb signal is at H level, the A1hb’ signal is at H level, the A1b signal is at H level, or the A1hb signal is at HH level, the gate circuit 76B3 outputs an OFF signal to the disconnect circuit 50B3.

For example, if the B3b signal becomes H level due to a ground fault, the gate circuit 76B3 outputs an OFF signal to the disconnect circuit 50B3. When voltage Va and/or voltage Vb drops due to a ground fault and the Cb signal becomes H level, the gate circuit 76B3 outputs an OFF signal to the disconnect circuit 50B3. When the A1hb signal becomes H level due to overvoltage, the gate circuit 76B3 outputs an OFF signal to the disconnect circuit 50B3. When the A1b signal becomes H level due to a ground fault, the gate circuit 76B3 outputs an OFF signal to the disconnect circuit 50B3.

The gate circuit 76C receives as inputs the inverted Cb signal and the output signal from the gate circuit 777. The gate circuit 777 is an AND gate, with a NOT gate connected to one of its input terminals. The gate circuit 777 receives, as inputs, the control signal for the disconnect circuit 50C output from the microcontroller 71, and the inverted A1hb’ signal. When at least one of the following conditions is satisfied: the control signal is at L level, the A1hb’ signal is at H level, or the Cb signal is at H level, the gate circuit 76C outputs an OFF signal to the disconnect circuit 50C. For example, if voltage Va and/or voltage Vb decreases due to a ground fault and the Cb signal becomes H level, the gate circuit 76C outputs an OFF signal to the disconnect circuit 50C. When the A1hb’ signal becomes H level due to overvoltage, the gate circuit 76C outputs an OFF signal to the disconnect circuit 50C.

### Latch Detection and Abnormal Modes

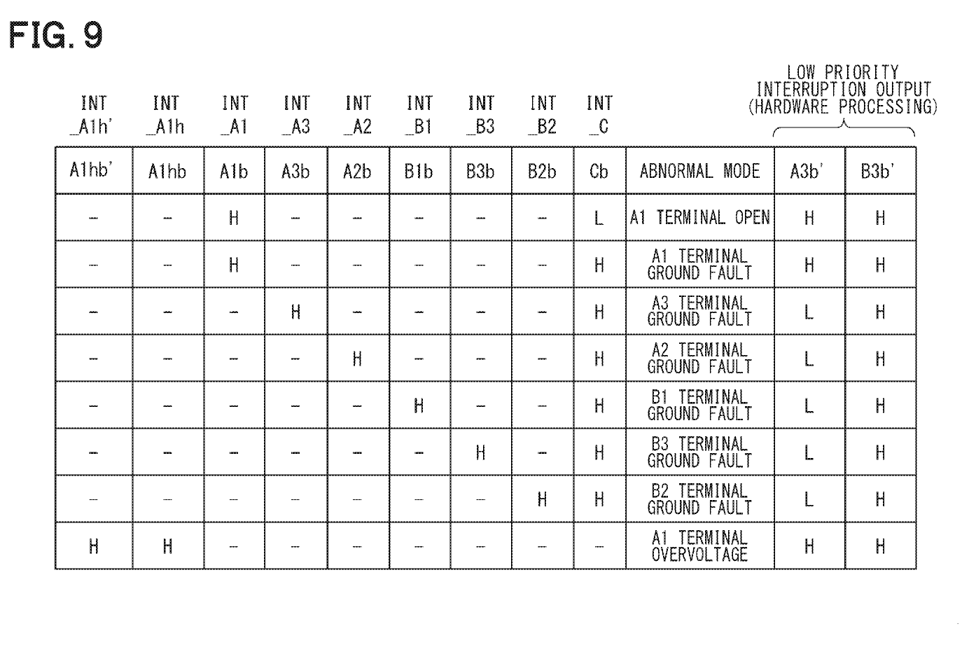

FIG. 9 shows an example of the relationship between each latch detection and abnormal modes. In other words, FIG. 9 shows the relationship between the state of the signals output from each latch 74 and provided to the INT terminal of the microcontroller 71, and the abnormal modes detected by the microcontroller 71. In FIG. 9, the states of the A3b’ and B3b’ signals, which are used to cut off power supply to the lower-priority loads 11A and 11B by hardware processing, are also shown.

As shown in FIG. 9, the microcontroller 71 detects that terminal 30A1 (A1 terminal) is open when the A1b signal obtained from the INT_A1 terminal is at H level and the Cb signal obtained from the INT_C terminal is at L level. Since the A1b signal is at H level, the A3b’ and B3b’ signals also become H level.

The microcontroller 71 detects that the terminal 30A1 is grounded when the A1b signal is at H level and the Cb signal is at H level. Since both the A1b signal and the Cb signal are at H level, the A3b’ and B3b’ signals also become H level.

The microcontroller 71 detects that the terminal 30A3 (A3 terminal) is grounded when the A3b signal obtained from the INT_A3 terminal is at H level and the Cb signal is at H level. In this case, the A3b' signal becomes L level, and since the Cb signal is at H level, the B3b’ signal becomes H level. Similarly, the microcontroller 71 detects that the terminal 30A2 (A2 terminal) is grounded when the A2b signal obtained from the INT_A2 terminal is at H level and the Cb signal is at H level. In this case, the A3b' signal becomes L level, and since the Cb signal is at H level, the B3b’ signal becomes H level.

The microcontroller 71 detects that the terminal 30B1 (B1 terminal) is grounded when the B1b signal obtained from the INT_B1 terminal is at H level and the Cb signal is at H level. In this case, the A3b’ signal becomes L level, and since the Cb signal is at H level, the B3b’ signal becomes H level. The microcontroller 71 detects that the terminal 30B3 (B3 terminal) is grounded when the B3b signal obtained from the INT_B3 terminal is at H level and the Cb signal is at H level. In this case, the A3b’ signal becomes L level, and since the Cb signal is at H level, the B3b’ signal becomes H level. The microcontroller 71 detects that the terminal 30B2 (B2 terminal) is grounded when the B2b signal obtained from the INT_B2 terminal is at H level and the Cb signal is at H level. In this case, the A3b’ signal becomes L level, and since the Cb signal is at H level, the B3b’ signal becomes H level.

The microcontroller 71 detects that the terminal 30A1 (A1 terminal) is experiencing overvoltage, that is, the voltage supplied from the power supply 10A is overvoltage (high voltage), when the A1hb signal obtained from the INT_A1hb terminal is at H level and the A1hb’ signal obtained from the INT_A1hb’ terminal is at H level. In this case, since the A1hb signal is at H level, the A3b’ signal becomes H level, and since both the A1hb signal and the A1hb’ signal are at H level, the B3b’ signal becomes H level.

### Control Method

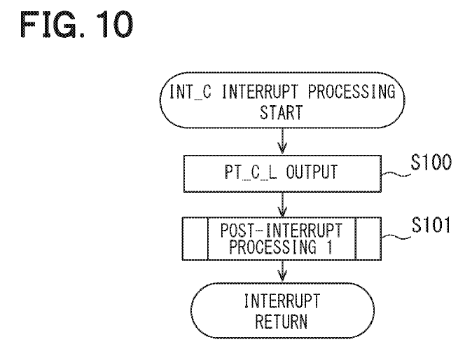

Next, the processing executed by the microcontroller 71 (processor), that is, the control method, will be described with reference to FIGS. 10 to 16. When the microcontroller 71 receives an interrupt request while all the disconnect circuits 50 are in the ON (conducting) state, the microcontroller 71 executes the following processing. FIG. 10 illustrates the INT_C interrupt processing. The H level of a signal corresponds to 1, and the L level corresponds to 0 (zero). Hereinafter, the H level may be indicated as 1 and the L level as 0.

When an H-level Cb signal is provided to the INT terminal (INT_C) for the shutoff circuit 50C, the microcontroller 71 executes the INT_C interrupt processing. When the voltage Va drops below the threshold value, the output of the comparator 73VA2 becomes H level, consequently causing the output of the gate circuit 75C to become H level as well, and the Cb signal output from the latch 74C also becomes H level. Similarly, when the voltage Vb drops below the threshold value, the output of the comparator 73VB2 becomes H level, consequently causing the output of the gate circuit 75C to become H level as well, and the Cb signal output from the latch 74C also becomes H level. In this manner, when at least one of the voltages Va or Vb falls below the threshold value, the Cb signal becomes H level.

As shown in FIG. 10, first, the microcontroller 71 outputs an L-level signal as a control signal from the PT terminal (PT_C) corresponding to the disconnect circuit 50C in S100. As a result, since the output of the gate circuit 777 becomes L level, even if the Cb signal, which is the cause of this interrupt, subsequently changes from H level to L level due to the latch being cleared, the gate circuit 76C can maintain the off signal (L-level signal) for the disconnect circuit 50C to keep it in the disconnection state. Next, the microcontroller 71 executes post-disconnection processing 1, which is the process performed after outputting the disconnect instruction to the disconnect circuit 50C in S101. When the post-disconnection processing 1 is completed, the microcontroller 71 terminates the series of processes.

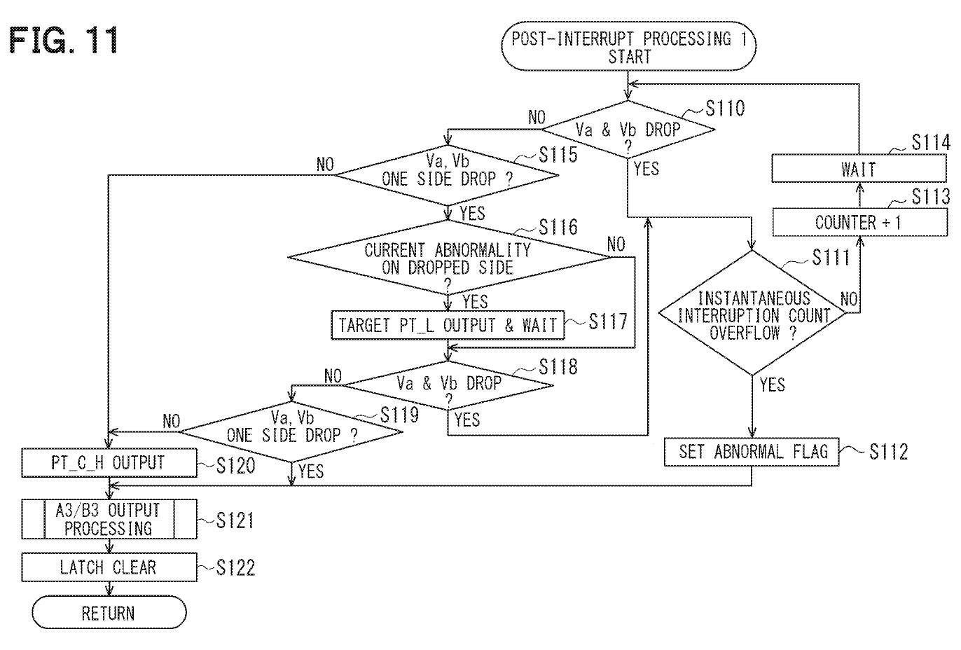

FIG. 11 illustrates post-disconnection processing 1. First, the microcontroller 71 determines whether both voltages Va and Vb have decreased in S110. The microcontroller 71 compares the values of voltages Va and Vb, acquired via the corresponding ADin terminals (AD_VA, AD_VB), with a previously stored threshold, and determines whether the voltages Va and Vb are below the threshold, that is, whether they have decreased. The threshold is, for example, a common value (an equal value) for both voltages Va and Vb.

If the voltages Va and Vb have decreased, the microcontroller 71 determines whether the momentary interruption counter has overflowed in S111. If an overflow has occurred, the abnormality flag is set in S112, and the process moves to the A3/B3 output processing in S121. If an overflow has not occurred, the momentary interruption counter is incremented, that is, its value is increased by +1 in S113, and after waiting for a predetermined time in S114, the processing from S110 onward is executed again.

If the determination in S110 is NO, the microcontroller 71 determines whether either one of the voltages Va or Vb is below the threshold, that is, whether either Va or Vb has decreased in S115. If either Va or Vb has decreased, it is determined whether there is an abnormality in the current on the side where the voltage has decreased in S116. The microcontroller 71 compares the values of the currents Ia1, Ia2, Ia3, Ib1, Ib2, and Ib3, which are obtained via the corresponding ADin terminals, with the pre-stored threshold values, and determines whether the current exceeds the threshold, that is, whether an abnormality is present. For example, if the voltage Va has decreased, it is determined whether there is an abnormality in the currents Ia1, Ia2, and Ia3 on the main line 41A side. If the voltage Vb has decreased, it is determined whether there is an abnormality in the currents Ib1, Ib2, and Ib3 on the main line 41B side.

If there is no abnormality in the current on the side where the voltage has decreased, the process proceeds to S118. If there is an abnormality in the current on the side where the voltage has decreased, the microcontroller 71 outputs an L-level control signal from the PT terminal corresponding to the target disconnect circuit 50 in which the current abnormality was detected, and waits for a predetermined period of time in S117. For example, if the current Ia3 exceeds the threshold value, the microcontroller 71 outputs an L-level signal from the PT terminal (PT_A3) corresponding to the disconnect circuit 50A3. As a result, the output of the gate circuit 772 becomes L-level, and the gate circuit 76A3 outputs an OFF signal to the disconnect circuit 50A3.

Next, the microcontroller 71 again determines whether both voltages Va and Vb have decreased in S118. If both voltages Va and Vb have decreased, the microcontroller 71 executes the processing from S111 onward. If the determination in S118 is NO, the microcontroller 71 again determines whether either one of the voltages Va or Vb has decreased in S119. If either one of the voltages Va or Vb has decreased, the process transitions to the A3/B3 output processing in S121.

If the determination in S115 or S119 is NO, that is, if both voltages Va and Vb are above the threshold, the microcontroller 71 outputs a high-level control signal from the PT terminal (PT_C) corresponding to the disconnect circuit 50C in S120. If the voltage Va is below the overvoltage threshold, the A1hb’ signal becomes low level, so all inputs to the gate circuit 777 become H level. Therefore, the output of the gate circuit 777 becomes H level. In addition, since the voltages Va and Vb are above the ground fault detection threshold, the Cb signal becomes L level. Therefore, all inputs to the gate circuit 76C become H level, and the gate circuit 76C outputs an ON signal to the disconnect circuit 50C.

Next, the microcontroller 71 executes the A3/B3 output processing in S121. After the A3/B3 output processing, the microcontroller 71 executes the latch clear processing in S122, thereby completing the series of post-disconnection processing 1. In S123, the microcontroller 71 outputs a high-level signal from the PT terminal for latch clearing (PT_LC). As a result, a high-level signal is provided to the R terminal of each latch 74, and the data held in the latch 74 is cleared (reset).

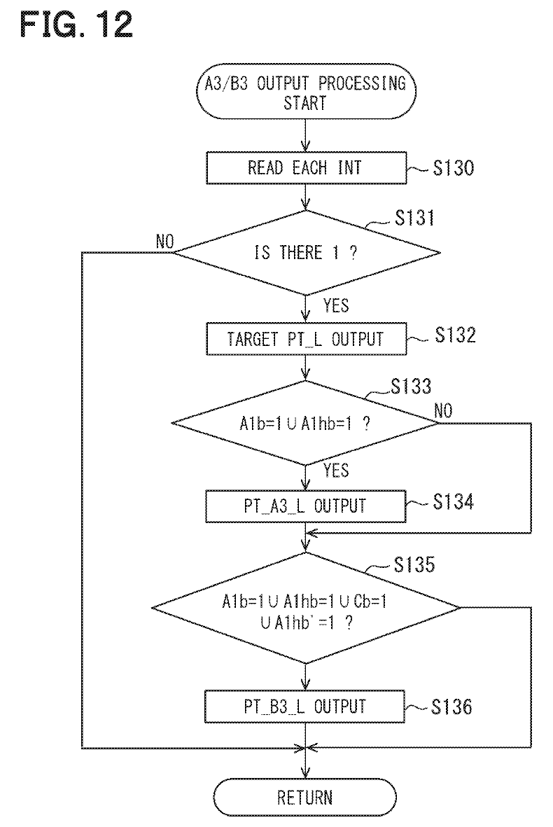

FIG. 12 illustrates the A3/B3 output processing. First, the microcontroller 71 reads the data from each INT terminal in S130. Next, the microcontroller 71 determines whether the read data contains a “1” (H level), that is, whether an abnormality has been detected in S131. If there is no “1,” the microcontroller 71 terminates the series of processes. If there is a “1,” the microcontroller 71 outputs an L level control signal from the PT terminal corresponding to the relevant disconnect circuit 50 (S132). For example, if the A1b signal is “1,” the microcontroller 71 outputs a low-level signal from the PT terminal (PT_A1) corresponding to the disconnect circuit 50A1.

Next, the microcontroller 71 determines whether at least one of the A1b signal and the A1hb signal is “1” (step S133). In other words, it determines whether at least one of the A1b signal and the A1hb signal is at the H level. If the determination in S133 is YES, in order to suppress power consumption on the main line 41A side, the microcontroller 71 outputs a low-level control signal from the PT terminal (PT_A3) corresponding to the disconnect circuit 50A3 in S134. As a result, the output of the gate circuit 772 becomes L-level, and the gate circuit 76A3 outputs an OFF signal to the disconnect circuit 50A3. In this manner, the microcontroller 71 controls the system so as to block power supply to the lower-priority load 11A. After execution in S134, the process is shifted to S135.

If the determination in S133 is NO, the microcontroller 71 determines whether at least one of the A1b signal, A1hb signal, Cb signal, or A1hb’ signal is 1 in S135. In other words, it determines whether at least one of the A1b signal, A1hb signal, Cb signal, or A1hb' signal is at a high level. If step S135 results in a NO determination, the microcontroller 71 terminates the A3/B3 output processing.

If the determination in S135 is YES, in order to suppress power consumption on the main line 41B side, the microcontroller 71 outputs a control signal at the L level from the PT terminal (PT_B3) corresponding to the disconnect circuit 50B3 in S136. As a result, the output of the gate circuit 774 becomes L level, and the gate circuit 76B3 outputs an OFF signal to the disconnect circuit 50B3. In this manner, the microcontroller 71 controls the system so as to block power supply to the lower-priority load 11B. After the execution in S136, the microcontroller 71 terminates the A3/B3 output processing.

By executing the A3/B3 output processing in this manner, for example, even if a latch clear is performed in S123, it is possible to maintain the disconnection state (off) of the disconnect circuit 50A3 and the disconnect circuit 50B3.

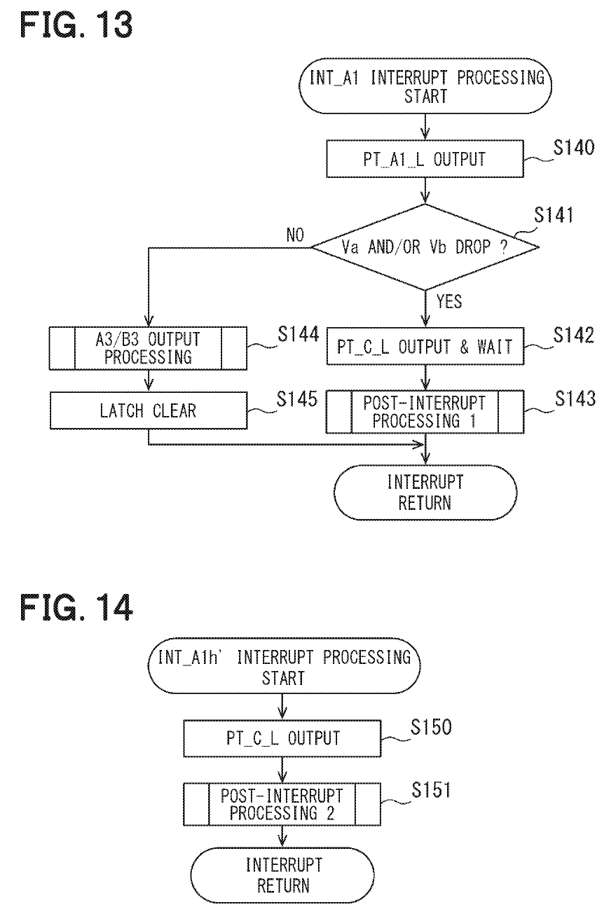

FIG. 13 illustrates the INT_A1 interrupt processing. When an A1b signal at the H level is provided to to the INT terminal (INT_A1) for the disconnect circuit 50A1, the microcontroller 71 executes the INT_A1 interrupt processing. When the value of the current Ia1 exceeds the threshold, the output of the comparator 73A1 becomes H level, and the A1b signal output from the latch 74A1 also becomes H level.

As shown in FIG. 13, first, the microcontroller 71 outputs an low-level signal as a control signal from the PT terminal (PT_A1) corresponding to the disconnect circuit 50A1 in S140. As a result, the output of the gate circuit 771 becomes L level, so that even after the latch is later cleared and the A1b signal, which is the cause of this interrupt, changes from H to L, the gate circuit 76A1 can continue to supply the disconnect circuit 50A1 with an OFF signal (L level signal) to maintain the disconnection state. Next, the microcontroller 71 determines whether the voltage Va and/or the voltage Vb is below the threshold, that is, whether it has decreased in S141. If a decrease is detected, the microcontroller 71 outputs a low-level control signal from the PT terminal (PT_C) corresponding to the disconnect circuit 50C, and waits for a predetermined period of time in S142. By means of the low-level control signal, the output of the gate circuit 777 becomes L level, and the gate circuit 76C outputs an OFF signal to the disconnect circuit 50C. After waiting, the microcontroller 71 executes the post-disconnection processing 1 shown in FIG. 11 (S143), and upon completion, ends the series of INT_A1 interrupt processing.

If the determination in S141 is NO, that is, if there is no decrease in voltages Va and Vb, the microcontroller 71 executes the A3/B3 output processing shown in FIG. 12 in S144. Next, the microcontroller 71 executes the latch clear process in S145, and then ends the series of INT_A1 interrupt processing. For example, if a ground fault occurs at the terminal 30A1, the processing in S144 outputs an OFF signal to the disconnect circuit 50A3. Therefore, even after the latch is cleared, the disconnection state of the disconnect circuit 50A3 can be maintained.

Although not illustrated, the INT_A2 interrupt processing, INT_A3 interrupt processing, INT_B1 interrupt processing, INT_B2 interrupt processing, and INT_B3 interrupt processing are similar to the aforementioned INT_A1 interrupt processing. For example, in the case of INT_A2 interrupt processing, in S140, it is possible to output an L-level signal as a control signal from the PT terminal (PT_A2) corresponding to the disconnect circuit 50A2. As described above, the microcontroller 71 first disconnects the disconnect circuits 50A1, 50A2,50A3, 50B1, 50B2, and 50B3 corresponding to each terminal 30. If at least one of the voltages Va or Vb falls below the threshold even after these circuits are disconnected, the microcontroller controls the system to disconnect the disconnect circuit 50C.

FIG. 14 illustrates the INT_A1h’ interrupt processing. When an H-level A1hb’ signal is provided to the INT terminal (INT_A1h’), the microcontroller 71 executes the INT_A1h’ interrupt processing. When the voltage Va exceeds the overvoltage threshold, the output of comparator 73AH2 becomes H level, and the A1hb’ signal output from latch 74AH2 also becomes H level.

As shown in FIG. 14, the microcontroller 71 first outputs an L level signal as a control signal from the PT terminal (PT_C) corresponding to the disconnect circuit 50C in S150. As a result, since the gate circuit 777 becomes L level, even if the A1hb’ signal, which is the cause of this interrupt, subsequently changes from H level to L level due to the latch being cleared, the gate circuit 76C can maintain the output of the off signal (L-level signal) for the disconnect circuit 50C to keep it in the disconnection state. Next, the microcontroller 71 executes the post-disconnection processing 2 (S151), which is the processing performed after outputting the disconnection instruction (OFF signal) to the disconnect circuit 50C. When the post-disconnection processing 2 is completed, the series of INT_A1H’ interrupt processing is completed.

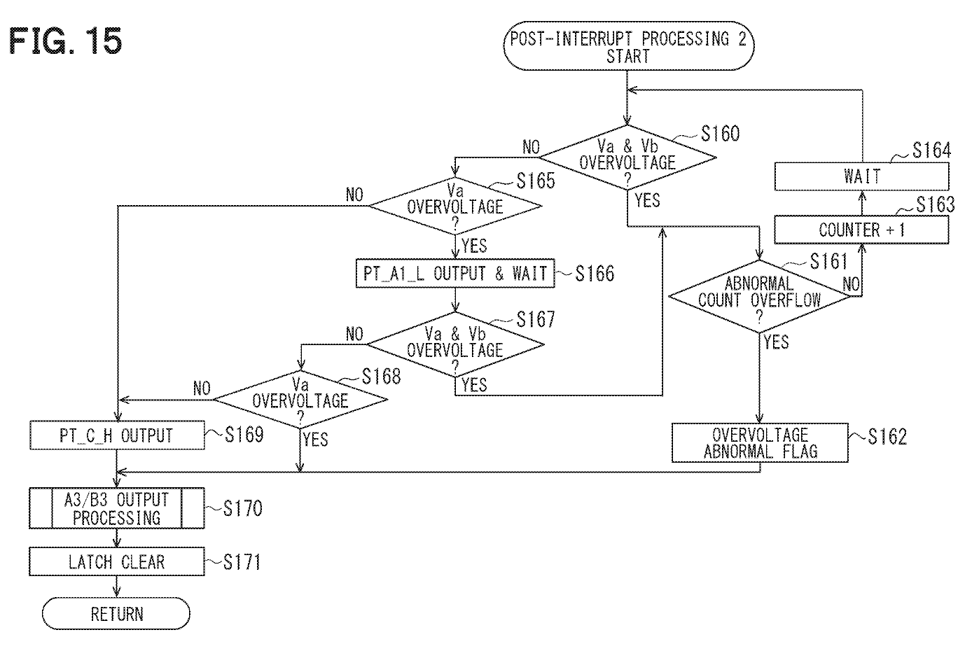

FIG. 15 illustrates the post-disconnection processing 2. The microcontroller 71 first determines whether both voltages Va and Vb exceed their respective thresholds, that is, whether an overvoltage condition exists in S160. The threshold values for overvoltage determination are stored in advance. For example, the threshold values are the same for both voltages Va and Vb. If voltages Va and Vb are in an overvoltage state, the microcontroller 71 determines whether the abnormality counter has overflowed in S161. If an overflow has occurred, the overvoltage abnormality flag is set in S162, and the process moves to the A3/B3 output processing in S170. If an overflow has not occurred, the abnormality counter is incremented, that is, its value is increased by +1 in S163, and after waiting for a predetermined period in S164, the processing from S160 onward is executed again.

If the determination in S160 is NO, the microcontroller 71 determines whether the voltage Va on the power supply 10A side, which has a higher power supply capacity, is in an overvoltage state in S165. If the voltage Va is in an overvoltage state, in order to disconnect the disconnect circuit 50A1 closest to the power supply 10A, the microcontroller 71 outputs an L-level control signal from the corresponding PT terminal (PT_A1) and waits for a predetermined period in S166. By means of the L-level control signal, the output of gate circuit 771 becomes L-level, and gate circuit 76A1 outputs an OFF signal to the disconnect circuit 50A1.

Next, the microcontroller 71 again determines whether both voltages Va and Vb are in an overvoltage state in S167. If the voltages Va and Vb are in an overvoltage state, the microcontroller 71 executes the processes starting from S161. If the determination in S167 is NO, the microcontroller 71 again determines whether the voltage Va is in an overvoltage state in S168. If the voltage Va is in an overvoltage state, the process shifts to the A3/B3 output processing in S170.

If the determination in S165 and S168 is NO, that is, if the voltage Va is not in an overvoltage state, the microcontroller 71 outputs an H-level control signal from the PT terminal (PT_C) in S169. If the voltage Va is below the overvoltage threshold, the A1hb’ signal becomes L level, so both inputs to the gate circuit 777 become H level. Additionally, if the voltages Va and Vb are at or above the threshold for ground fault determination, the Cb signal becomes L level, so both inputs to the gate circuit 76C become H level. Therefore, the gate circuit 76C outputs an ON signal to the disconnect circuit 50C.

Next, the microcontroller 71 executes the A3/B3 output processing in S170. After the A3/B3 output processing, the microcontroller 71 executes latch clear processing in S171, thereby completing the series of post-disconnection processing 2.

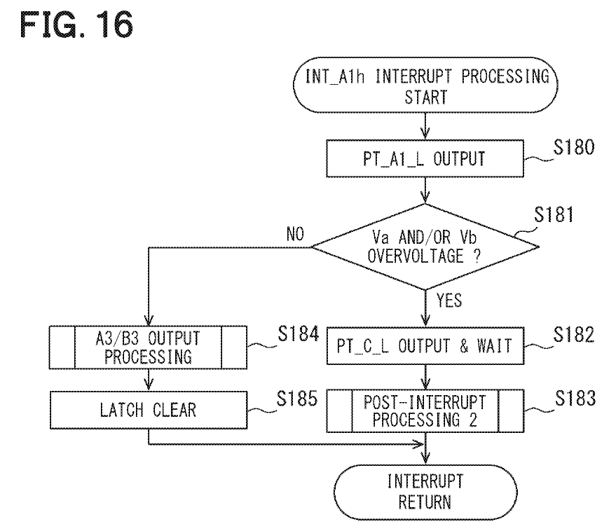

FIG. 16 illustrates the INT_A1h interrupt processing. When an A1hb signal at H level is input to the INT terminal (INT_A1h), the microcontroller 71 executes the INT_A1h interrupt processing. When the voltage Va exceeds the overvoltage threshold, the output of comparator 73AH1 becomes H level, and the A1hb signal output from the latch 74AH1 also becomes H level.

As shown in FIG. 16, first, the microcontroller 71 outputs an L-level signal as a control signal from the PT terminal (PT_A1) in S180. As a result, the output of gate circuit 771 becomes L level, so even after the latch is cleared and the A1b signal, which is the cause of this interrupt, changes from H level to L level, the gate circuit 76A1 can continue to output the OFF signal (L level signal) to the disconnect circuit 50A1 to maintain the disconnection state. Next, the microcontroller 71 determines whether the voltage Va and/or the voltage Vb is in an overvoltage condition in S181. In the case of overvoltage, the microcontroller 71 outputs an L-level control signal from the PT terminal (PT_C) and waits for a predetermined period in S182. With the L level output, the output of gate circuit 777 becomes L level, and the gate circuit 76C outputs an OFF signal to the disconnect circuit 50C. After waiting, the microcontroller 71 executes the post-disconnection processing 2 shown in FIG. 15 (S183), and upon completion, ends the series of INT_A1h interrupt processing.

If the determination in S181 is NO, that is, when the voltages Va and Vb are not in an overvoltage condition, the microcontroller 71 executes the A3/B3 output processing shown in FIG. 12 (S184). Next, the microcontroller 71 executes the latch clear processing in S185, and then ends the series of INT_A1h interrupt processing.

### Example of Operation in Abnormal Conditions

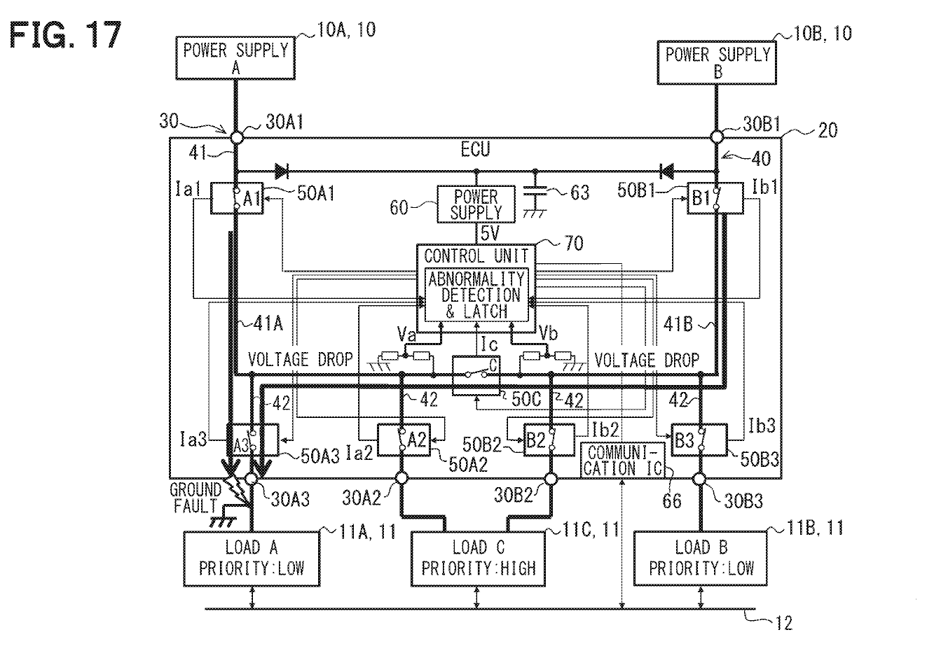

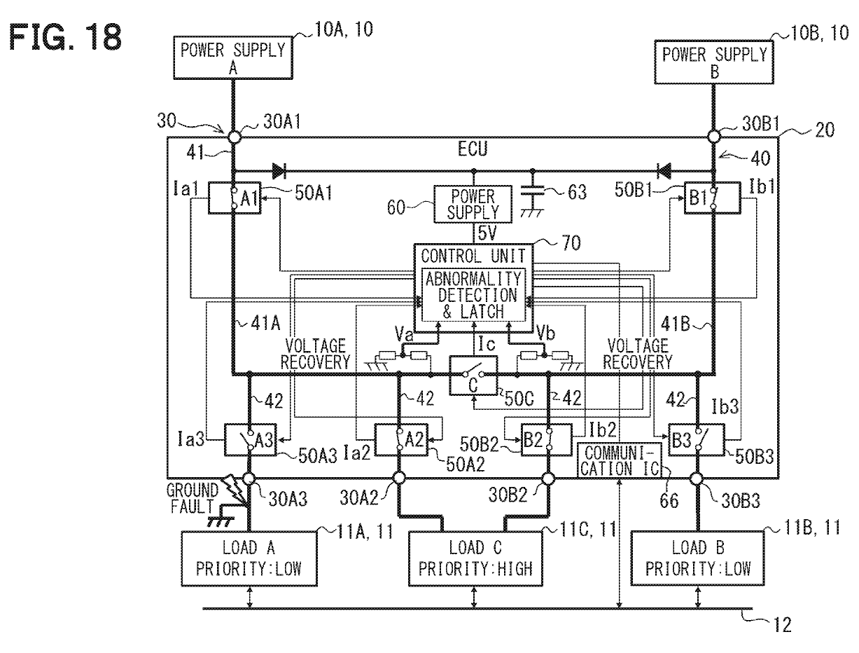

FIGS. 17 and 18 show an example of the operation when a ground fault occurs at the terminal 30A3 (A3 terminal). As shown in FIG. 17, when a ground fault occurs at the terminal 30A3, current flows into the ground fault location as indicated by the solid arrow, causing the voltages of the main lines 41A and 41B to drop, which in turn leads to a decrease in the divided voltages Va and Vb. When the current Ia3 of the disconnect circuit 50A3 closest to the ground fault location exceeds the threshold value and the voltage Va falls below the ground fault threshold, the A3b signal goes to the H level, and the gate circuit 76A3 outputs an OFF signal to the disconnect circuit 50A3. When at least one of the voltages Va or Vb falls below the threshold, the Cb signal goes to the H level, and the gate circuit 76C outputs an OFF signal to the disconnect circuit 50C. When the Cb signal goes to the H level, the B3b’ signal also goes to the H level, and the gate circuit 76B3 outputs an OFF signal to the disconnect circuit 50B3.

In the present embodiment, the threshold values of the comparators 73VA1 and 73VB1 are higher than those of the comparators 73VA2 and 73VB2. Therefore, an OFF signal is first output to the disconnect circuit 50A3. Even if an OFF signal is output to the disconnect circuit 50A3 and the voltage does not recover, when at least one of the voltages Va or Vb falls below the threshold of the corresponding comparator 73VA2 or 73VB2, an OFF signal is output to the disconnect circuit 50C. Additionally, an OFF signal is output to the disconnect circuit 50B3. If, after the disconnect circuit 50C is turned OFF, the voltages Va and Vb recover to or above the threshold, an ON signal is output to the disconnect circuit 50C by the interrupt processing of the microcontroller 71 described above. FIG. 18 shows the OFF states of disconnect circuits 50A3, 50B3, and 50C. The remaining disconnect circuits 50A1, 50A2, 50B1, and 50B2 are in the ON (conducting) state.

First, since an OFF signal is output to the disconnect circuit 50A3, if this operation causes the voltages Va and Vb to recover, it is possible to avoid turning OFF the disconnect circuit 50C on the main line 41. Even if the disconnect circuit 50C is turned OFF, electric power can still be supplied to the high-priority load 11C via the route of the power supply 10A, the main line 41A, and the disconnect circuit 50A2, as well as via the route of the power supply 10B, the main line 41B, and the disconnect circuit 50B2. Thus, power supply can be maintained.

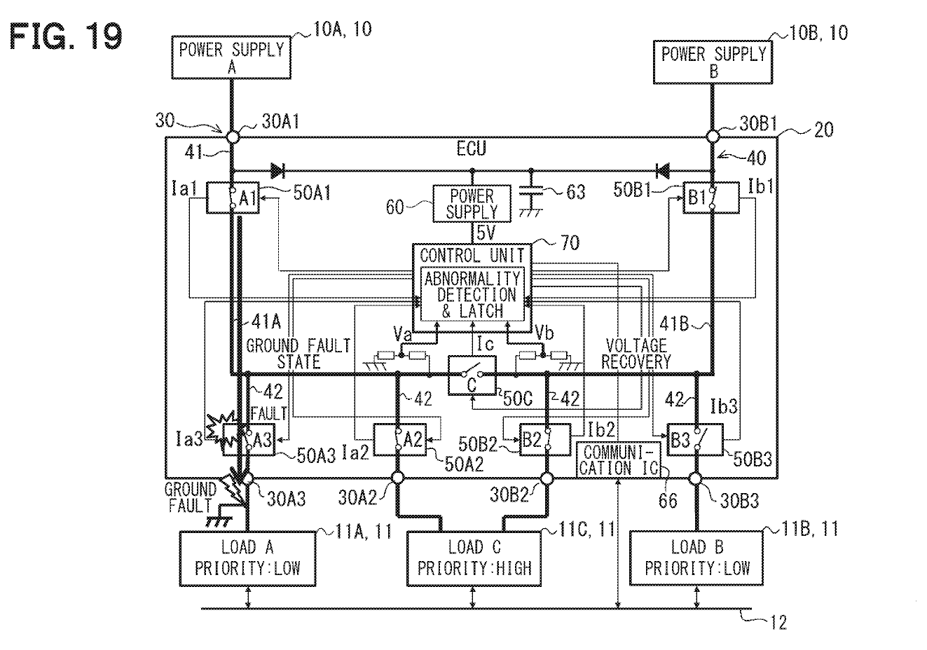

FIG. 19 shows an example of operation when a ground fault occurs at the terminal 30A3 and the terminal 30A3 side cannot be disconnected. In other words, it shows an example of operation when the disconnect circuit 50A3 cannot be turned OFF due to a fault such as being stuck in the ON state. As described above, first, the gate circuit 76A3 outputs an OFF signal to the disconnect circuit 50A3. However, due to being stuck in the ON state, the disconnect circuit 50A3 does not turn OFF. In this case, the voltages Va and Vb do not recover, and at least one of the voltages Va or Vb falls below the threshold value of the corresponding comparator 73VA2 or 73VB2. Therefore, the gate circuit 76C outputs an OFF signal to the disconnect circuit 50C. Additionally, the gate circuit 76B3 outputs an OFF signal to the disconnect circuit 50B3. FIG. 19 shows the fault (stuck ON) of the disconnect circuit 50A3 and the OFF states of the disconnect circuits 50B3 and 50C. The remaining disconnect circuits 50A1, 50A2, 50B1, and 50B2 are in the ON state.

By turning off the disconnect circuit 50C, the main line 41B can be disconnected from the main line 41A in the ground fault state. As a result, the main line 41B recovers its voltage. Even if the disconnect circuit 50A3 closest to the ground fault location has a fault (stuck ON), power can still be supplied to the high-priority load 11C via the route of the power supply 10B, the main line 41B, and the disconnect circuit 50B2. Thus, power can be supplied to one of the redundant configurations provided in load 11C, allowing its function to be maintained. In addition, by turning off the disconnect circuit 50B3, power from the power supply 10B can be preferentially supplied to the load 11C. This also enables the function of the high-priority load 11C to be maintained.

When a ground fault occurs at the terminal 30B3 (B3 terminal), the operation will be the same as when a ground fault occurs at terminal 30A3. As one example in this embodiment, the disconnect circuit 50A3 corresponding to the low-priority load 11A is not turned off. For example, if the disconnect circuit 50B3 becomes stuck in the ON state, the main line 41A will recover voltage by turning off disconnect circuit 50C. Since the power supply 10A has a higher power supply capacity than power supply 10B, the disconnect circuit 50A3 does not need to be turned off. For example, in a configuration where the power supply capacities of power supplies 10A and 10B are approximately equal to each other, the disconnect circuit 50A3 may be turned off together with the disconnect circuit 50C.

If a ground fault occurs at the terminal 30A2 (A2 terminal), the operation will be the same as when a ground fault occurs at the terminal 30A3. Electric power can be supplied to load 11C, which has a higher priority for power supply, via the route of the power supply 10B, the main line 41B, and the disconnect circuit 50B2. Even if the disconnect circuit 50A2 is stuck in the ON state, the main line 41B can be restored to voltage by turning off the disconnect circuit 50C. By turning off the disconnect circuit 50B3, electric power can be preferentially supplied to the load 11C. If a ground fault occurs at the terminal 30B2 (B2 terminal), the operation will be the same as when a ground fault occurs at the terminal 30B3. Electric power can be supplied to the load 11C, which has a higher priority for power supply, via the route of the power supply 10A, the main line 41A, and the disconnect circuit 50A2.

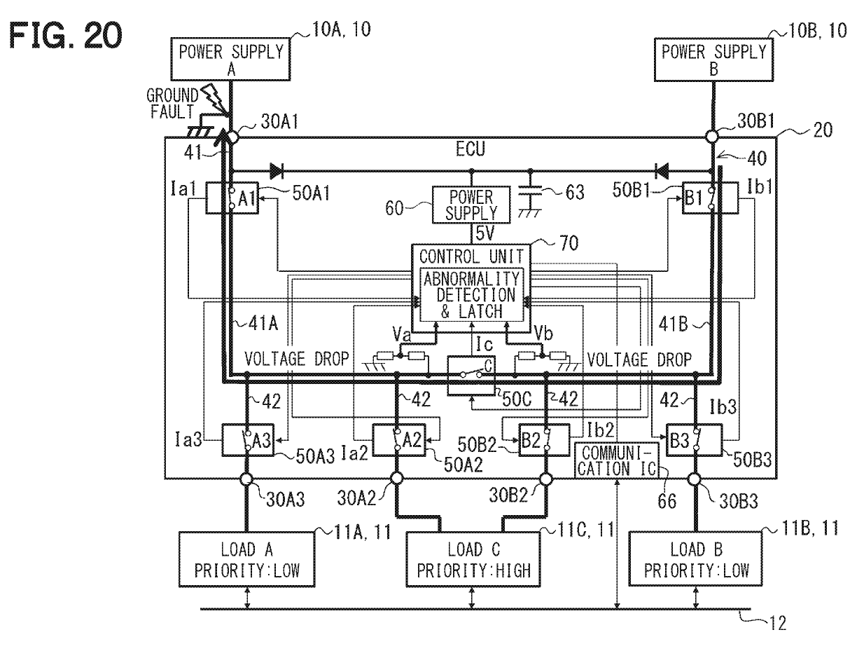

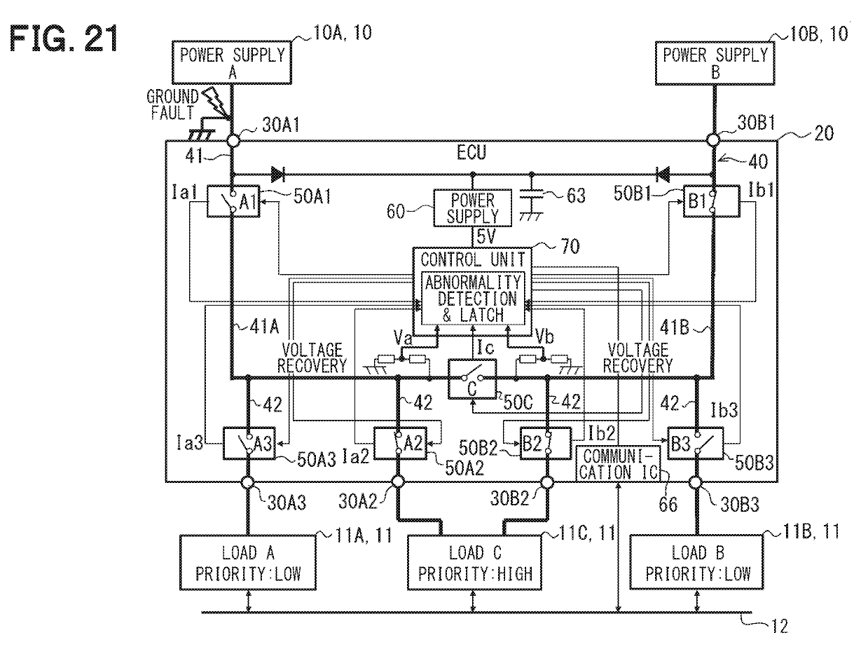

FIGS. 20 and 21 show an example of the operation when a ground fault occurs at the terminal 30A1 (A1 terminal). As shown by the solid arrows in FIG. 20, current flows into the ground fault location, causing the voltages of main lines 41A and 41B to drop, which in turn decreases the respective divided voltages Va and Vb. When the current Ia1 of the disconnect circuit 50A1 closest to the ground fault location exceeds the threshold value, the A1b signal goes to H level, and the gate circuit 76A1 outputs an OFF signal to the disconnect circuit 50A1. When the A1b signal goes to H level, the A3b’ signal also goes to H level, and the gate circuit 76A3 outputs an OFF signal to the disconnect circuit 50A3. When at least one of the voltages Va or Vb falls below the threshold, the Cb signal goes to the H level, and the gate circuit 76C outputs an OFF signal to the disconnect circuit 50C. Further, when the A1b signal and/or the Cb signal goes to H level, the B3b’ signal goes to H level, and the gate circuit 76B3 outputs an OFF signal to the disconnect circuit 50B3.

In the present embodiment, an OFF signal is first output to the disconnect circuit 50A1. An OFF signal is also output to the disconnect circuit 50A3. If the voltage does not recover even after an OFF signal is output to the disconnect circuit 50A1; and at least one of the voltages Va or Vb falls below the threshold of the comparators 73VA2 or 73VB2, an OFF signal is output to the disconnect circuit 50C. Additionally, an OFF signal is output to the disconnect circuit 50B3. If, after turning off the disconnect circuit 50C, the voltages Va and Vb become equal to or greater than the threshold, an ON signal is output to the disconnect circuit 50C by the interrupt processing of the aforementioned microcontroller 71. FIG. 21 shows the OFF state of disconnect circuits 50A1, 50A3, 50B3, and 50C. The remaining disconnect circuits 50A2, 50B1, and 50B2 are in the ON state.

If the voltages Va and Vb recover by outputting an OFF signal to the disconnect circuit 50A1, it is possible to avoid turning off the disconnect circuit 50C and, consequently, turning off the disconnect circuit 50B3. Even if the disconnect circuit 50C is turned off, power can still be supplied to the high-priority load 11C via the path including the power supply 10B, the main line 41B, and the disconnect circuit 50B2. By turning off the disconnect circuit 50B3, electric power can be preferentially supplied to the load 11C. By turning off the disconnect circuit 50A3, power can be preferentially supplied to load 11C even if the disconnect circuit 50C is on. Even if the disconnect circuit 50A1 is turned off to disconnect the power supply 10A and ECU 20, it is still possible to maintain power supply to the load 11C.

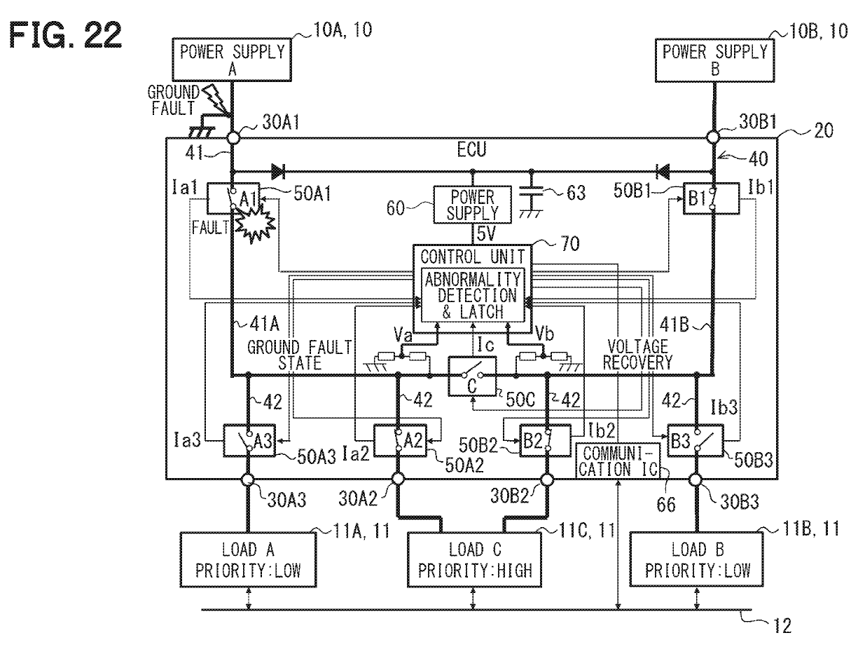

FIG. 22 shows an example of operation when a ground fault occurs at the terminal 30A1 and it is not possible to disconnect the terminal 30A1 side. In other words, it shows an example of operation when the disconnect circuit 50A1 cannot be turned off due to a fault such as a stuck-on condition. Even if the gate circuit 76A1 outputs an OFF signal to the disconnect circuit 50A1, the disconnect circuit 50A1 does not turn off due to being stuck in the ON state. In this case, the voltages Va and Vb do not recover, and at least one of the voltages Va or Vb falls below the threshold value of the comparator 73VA2 or 73VB2. Therefore, the gate circuit 76C outputs an OFF signal to the disconnect circuit 50C. Additionally, the gate circuit 76B3 outputs an OFF signal to the disconnect circuit 50B3. FIG. 22 shows a fault (stuck-on state) of the disconnect circuit 50A1, and the off states of the disconnect circuits 50A3, 50B3, and 50C. The remaining disconnect circuits 50A1, 50A2, 50B1, and 50B2 are in the ON state.

By turning off the disconnect circuit 50C, the main line 41B can be disconnected from the main line 41A in the ground fault state. As a result, the main line 41B recovers its voltage. Therefore, even if the disconnect circuit 50A1 closest to the ground fault location has a fault (stuck-on), it is still possible to supply power to the high-priority load 11C via the route of the power supply 10B, the main line 41B, and the disconnect circuit 50B2. In addition, by turning off the disconnect circuit 50B3, power from the power supply 10B can be preferentially supplied to the load 11C.

If an overvoltage abnormality occurs at the terminal 30A1, the operation will be the same as when a ground fault occurs at the terminal 30A1. When an overvoltage abnormality occurs at the terminal 30A1, the voltage Va exceeds the overvoltage threshold, and the A1hb signal goes to the H level. As a result, the gate circuit 76A1 outputs an OFF signal to disconnect circuit 50A1, and the gate circuit 76A3 outputs an OFF signal to the disconnect circuit 50A3. When the A1hb’ signal goes to the H level, the gate circuit 76C outputs an OFF signal to the disconnect circuit 50C. Additionally, the gate circuit 76B3 outputs an OFF signal to the disconnect circuit 50B3.

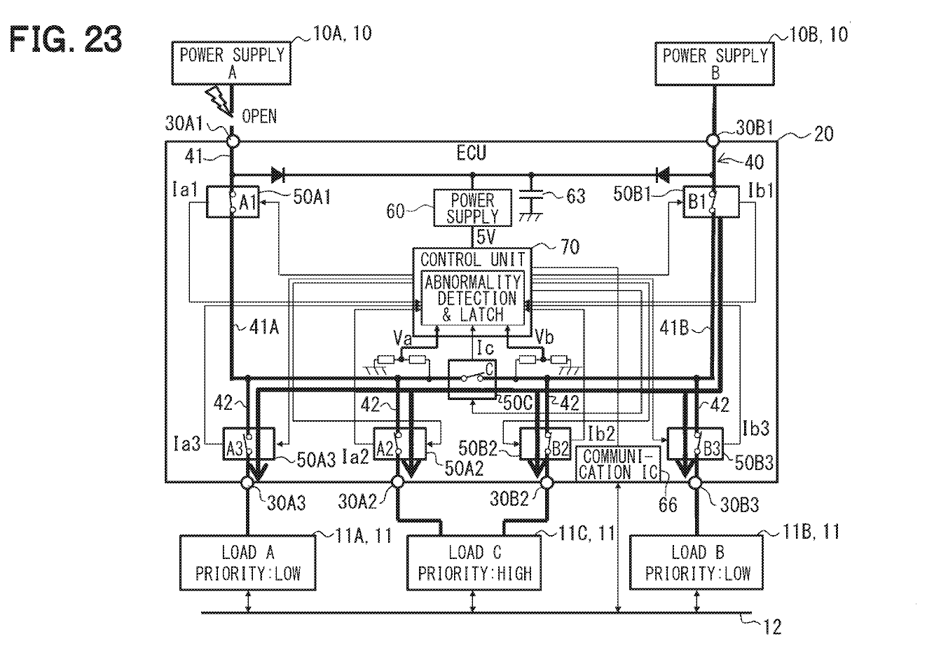

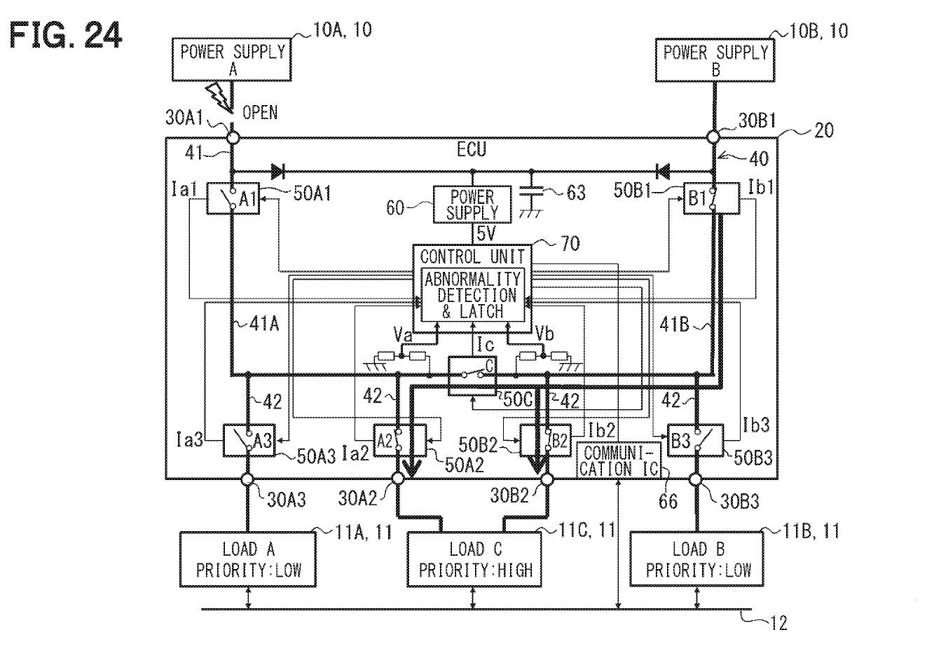

FIGS. 23 and 24 show an example of operation when an open fault occurs at the terminal 30A1. Due to the open circuit, the supply of power from the power supply 10A to the ECU 20 is interrupted. Therefore, electric current supplied from the power supply 10B flows to each load 11. When the current Ia1 of the disconnect circuit 50A1 closest to the open location exceeds the threshold shared for ground faults and open circuits, the A1b signal goes to H level, and the gate circuit 76A1 outputs an off signal to the disconnect circuit 50A1. Additionally, the gate circuit 76A3 outputs an OFF signal to the disconnect circuit 50A3, and the gate circuit 76B3 outputs an OFF signal to the disconnect circuit 50B3. FIG. 24 shows the OFF state of the disconnect circuits 50A1, 50A3, and 50B3. The remaining disconnect circuits 50A2, 50B1, 50B2, and 50C are in the ON state.

Even if power supply from the power supply 10A is interrupted due to an open circuit, by turning off the disconnect circuit 50A3, the power from power supply 10B can be preferentially supplied to the load 11C. Similarly, by turning off the disconnect circuit 50B3, power from the power supply 10B can be preferentially supplied to load 11C.

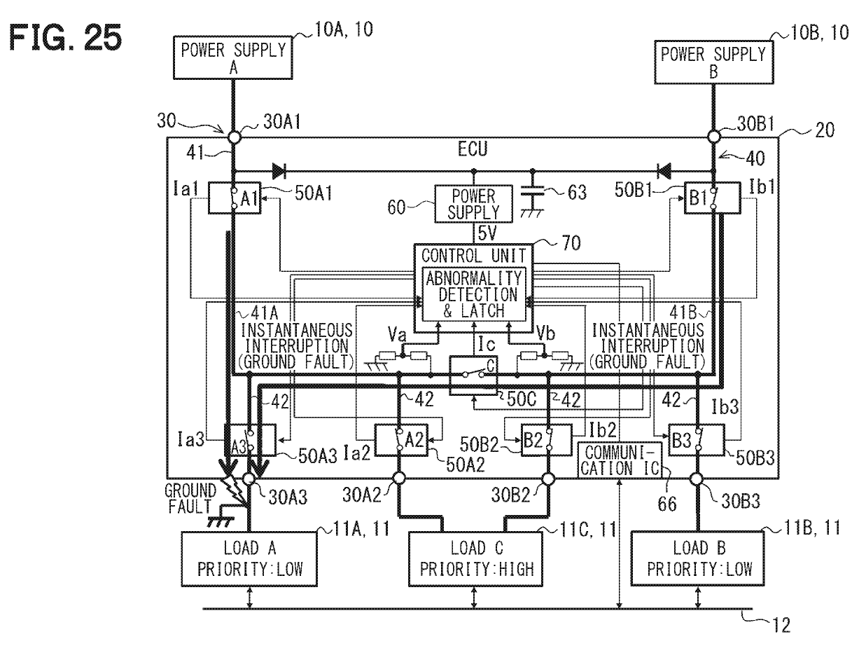

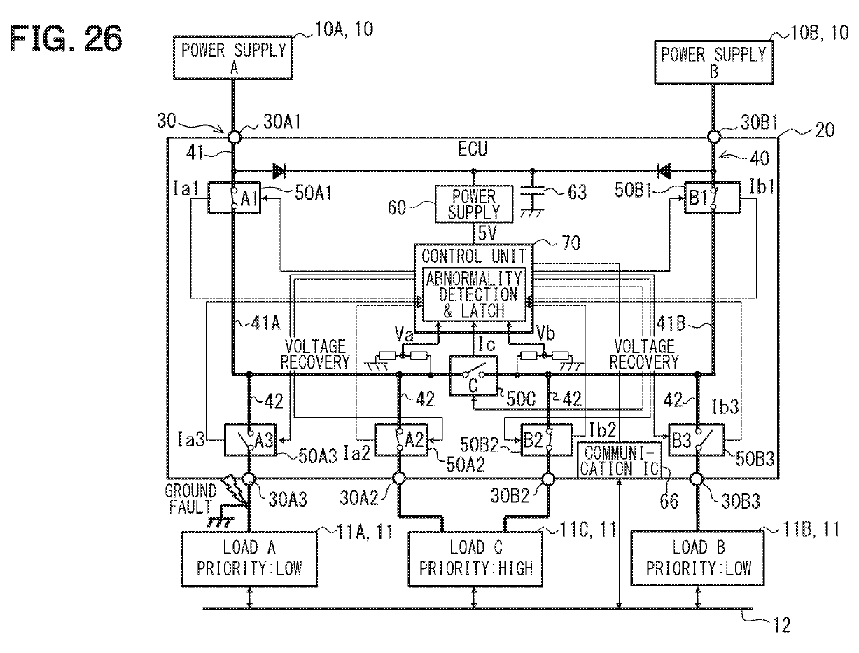

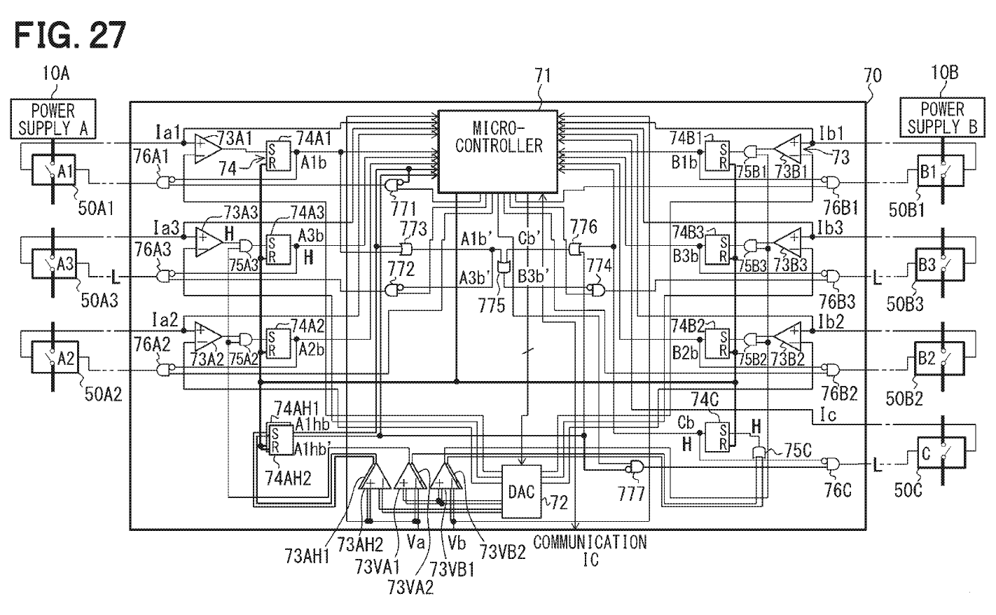

FIGS. 25 and 26 show an example of operation when a ground fault instantaneous interruption occurs, due to an off-delay. This shows an example of operation when a momentary interruption occurs due to a ground fault, caused by the off-delay of the switch in the disconnect circuit 50. In FIGS. 25 and 26, as in FIG. 17, an example is shown where a ground fault occurs at the terminal 30A3. FIG. 27 shows the operation of the control unit during the occurrence of a ground fault instantaneous interruption.

The disconnect circuit 50 includes a power-on reset circuit (not shown). When a ground fault occurs at the terminal 30A3 and the resistance near the ground fault is low, the divided voltage values Va and Vb of the main lines 41A and 41B drop sharply. Therefore, the ground fault is detected by the current Ia3 and the voltages Va and Vb, and “H” is set at the S terminals of the latches 74A3 and 74C. However, due to a delay, the OFF (interruption) operation of the disconnect circuits 50A3 and 50C does not occur in time, and when the main lines 41A and 41B experience instantaneous interruption (ground fault), the disconnect circuit 50 performs a power-on reset.

The ECU 20 according to the present embodiment includes a capacitor 63. Therefore, even if an instantaneous interruption occurs, the voltage of the control unit 70 is maintained. In other words, the data in the latch 74 is retained. Therefore, when recovering (restarting) from a power-on reset, as shown in FIG. 27, an H-level signal is output from latch 74A3 as the A3b signal, and an OFF signal is output to the disconnect circuit 50A3. Additionally, an H-level signal is output from the latch 74C as the Cb signal, and an OFF signal is output to the disconnect circuit 50C. Since the B3b’ signal becomes H level based on the Cb signal, an OFF signal is output to the disconnect circuit 50B3. An ON signal is output to the other disconnect circuits 50A1, 50A2, 50B1, and 50B2. Therefore, it is possible to suppress the main lines 41A and 41B from momentarily interrupting (ground fault) again. That is, it is possible to suppress repeated momentary interruptions.

### Summary of the First Embodiment

According to the present embodiment, the ECU 20 is provided not only with the disconnect circuits 50A1, 50A2, 50A3, 50B1, 50B2, and 50B3 (terminal disconnect circuits) corresponding to the terminals 30, but also with the disconnect circuit 50C (main-line disconnect circuit) on the main line 41. The control unit 70 outputs an OFF signal to the corresponding terminal disconnect circuit among the terminal disconnect circuits whose current exceeds the current threshold, and to the main-line disconnect circuit, when at least one of the current flowing through the disconnect circuit 50 or the voltage of the power supply wiring 40 satisfies a predetermined abnormality detection condition. Therefore, even if the terminal disconnect circuit closest to the fault location such as a ground fault cannot be switched off when an abnormality such as a ground fault occurs, it is possible to prevent all loads 11 from being unable to receive power supply by switching off the main-line disconnect circuit. In other words, it is possible to maintain power supply to at least some of the loads 11.

As illustrated in the present embodiment, the loads 11 may include the load 11C (first load) having a high priority for power supply, and the loads 11A and 11B (second loads) having a low priority for power supply. The terminal 30A2 electrically connected to the main line 41A and the terminal 30B2 electrically connected to the main line 41B may both be connected to the common load 11C. Accordingly, even if the disconnect circuit 50C is switched off, it is possible to maintain power supply to the high-priority load 11C. Furthermore, the control unit 70 may control at least one of the disconnect circuits 50A3 and 50B3, corresponding to loads 11A and 11B, to the disconnection state, in conjunction with controlling the disconnect circuit 50C to the disconnection state or controlling the disconnect circuit 50A1 to the disconnection state. As a result, it is possible to secure the power supplied to the high-priority load 11C.

The control unit 70 may output an OFF signal to the disconnect circuit 50C when the value of the current flowing through the disconnect circuit 50C exceeds a predetermined threshold current. As illustrated in this embodiment, the control unit 70 may output an OFF signal to the disconnect circuit 50C when at least one of the divided voltage values Va or Vb of the main lines 41A and 41B falls below a predetermined threshold voltage. By monitoring only the voltages of the main lines 41A and 41B, instead of monitoring the voltage of each disconnect circuit 50, the configuration can be simplified.

The control unit 70 may output an OFF signal to the corresponding disconnect circuits 50A1, 50A2, 50A3, 50B1, 50B2, and 50B3 when any of the currents Ia1, Ia2, Ia3, Ib1, Ib2, or Ib3 exceeds a predetermined threshold current. As illustrated in this embodiment, the control unit 70 may output an OFF signal to the corresponding disconnect circuits 50A1, 50A2, 50A3, 50B1, 50B2, and 50B3 when at least one of the voltages Va or Vb falls below a predetermined threshold voltage and any of the currents Ia1, Ia2, Ia3, Ib1, Ib2, or Ib3 exceeds a predetermined threshold current. Since the voltages Va and Vb are also used, the current threshold for detecting a ground fault can be set lower. As a result, it is possible to enhance the disconnection responsiveness while suppressing erroneous disconnection.

The threshold voltage for disconnecting the disconnect circuit 50C and the threshold voltage for disconnecting the disconnect circuits 50A1, 50A2, 50A3, 50B1, 50B2, and 50B3 may be set to the same value. As illustrated in this embodiment, the threshold voltage for disconnecting the disconnect circuit 50C may be set lower than the threshold voltage for disconnecting the disconnect circuits 50A1, 50A2, 50A3, 50B1, 50B2, and 50B3. That is, the threshold values of the comparators 73VA2 and 73VB2 are lower than the threshold values of the comparators 73VA1 and 73VB1. Therefore, the disconnect circuits 50A1, 50A2, 50A3, 50B1, 50B2, and 50B3 corresponding to the abnormal condition are turned off first, and if the voltages Va and Vb continue to decrease, the disconnect circuit 50C is then turned off. As a result, unnecessary disconnection of the disconnect circuit 50C can be prevented.

As illustrated in this embodiment, the control unit 70 may turn on the disconnect circuit 50C when the voltages Va and Vb rise above the threshold voltage after the disconnect circuit 50C has been turned off. After ground fault detection and redundant operation are performed, if there is no fault in the disconnect circuit 50 that was turned off, disconnect circuit 50C is re-turned on. As a result, the redundant power supply state for the load 11 can be maintained.

As illustrated in present embodiment, the ECU 20 may further include the capacitor 63 connected to the power supply path from the power supply 10 to the control unit 70, and the control unit 70 may have a latch function for holding abnormality detection data. The abnormality detection data refers to data that is correlated with satisfying abnormality detection conditions. As described above, if a ground fault is detected but the corresponding disconnect circuit 50 is not turned off in time due to a delay, resulting in a momentary interruption of the main lines 41A and 41B, each disconnect circuit 50 performs a power-on reset. By providing the capacitor 63, it is possible to ensure the operating voltage of the control unit 70 even if a momentary interruption occurs. In other words, the control unit 70 can retain the abnormality detection data resulting from ground fault detection. As a result, upon recovery (restart), it is possible to turn off the corresponding disconnect circuit 50 using the abnormality detection data.

As illustrated in the present embodiment, the power supply capacity of the power supply 10A (first power supply) may be set higher than the power supply capacity of the power supply 10B (second power supply). In a configuration where the power supply capacity of the power supply 10A is high as described above, if the direction of current flowing from the disconnect circuit 50A1 to the terminal 30A1 is defined as the forward direction, the control unit 70 may control the disconnect circuit 50A1 to the disconnection state when the current flowing through the disconnect circuit 50A1 is positive or zero. As a result, not only the ground faults but also the open circuit can be detected.

In a configuration where the power supply capacity of the power supply 10A is high, the control unit 70 may output an OFF signal to both the disconnect circuit 50A1 and the disconnect circuit 50C when the voltage Va exceeds the overvoltage threshold. Accordingly, in the case where the supply voltage from the power supply 10A is overvoltage, even if the disconnect circuit 50A1 fails, turning off the disconnect circuit 50C can suppress the effect of the overvoltage on the main line 41B side.

The overvoltage threshold for disconnecting the disconnect circuit 50C and the overvoltage threshold voltage for interrupting the disconnect circuit 50A1 may be set to a common value. As illustrated in the present embodiment, the overvoltage threshold for disconnecting the disconnect circuit 50C may be set higher than the threshold voltage for disconnecting the disconnect circuit 50A1. The threshold of the comparator 73AH2 is higher than the threshold of the comparator 73AH1. Therefore, the disconnect circuit 50A1 is first turned off, and if the voltage Va continues to rise, the disconnect circuit 50C is then turned off. As a result, unnecessary disconnection of the disconnect circuit 50C can be prevented.

The ECU 20 according to the present embodiment includes the gate circuits 772 to 776 for blocking power supply to the low-priority loads 11A and 11B. In addition, the ECU 20 includes the latch 74 (SR latch) that retains the abnormality detection signal. Through hardware processing, the response speed of disconnection following abnormality detection can be improved.

### Modified Example

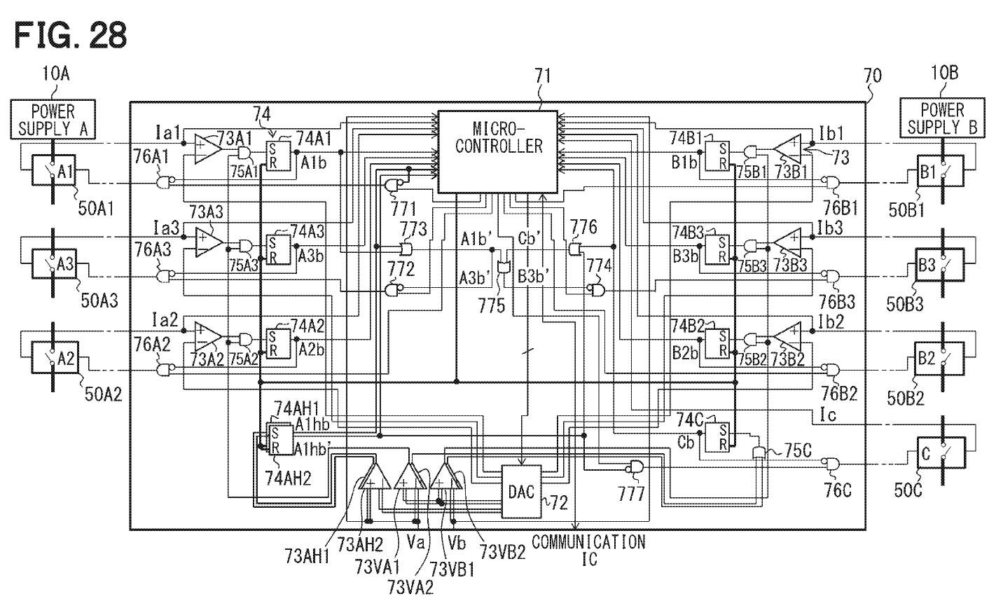

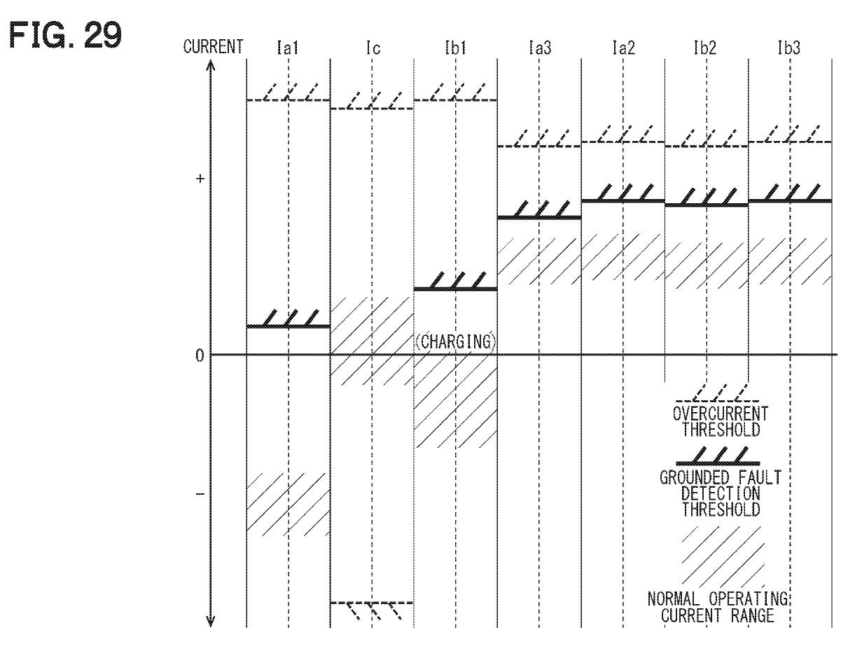

As shown in FIG. 28, the ECU 20 may not to detect an open-circuit fault at the terminal 30A1. The ECU 20 includes a gate circuit 75A1. The output signals of the comparators 73A1 and 73VA1 are provided to the gate circuit 75A1. The output signal of the gate circuit 75A1 is provided to the S terminal of the latch 74A1. The gate circuit 75A1 outputs an H-level signal when the current Ia1 exceeds the ground fault detection threshold and the voltage Va falls below the ground fault detection threshold voltage. As shown in FIG. 29, the ground fault detection threshold value compared with the current Ia1 is dedicated for ground fault detection and is not shared with open-circuit detection. When a ground fault occurs at the terminal 30A1, the current Ia1 flows in the opposite direction to that during normal operation, that is, in the positive direction. Therefore, a positive (+) value is set. By setting it to a low value close to zero, the disconnect circuit 50A1 can be quickly turned off by hardware processing in the event of a ground fault.

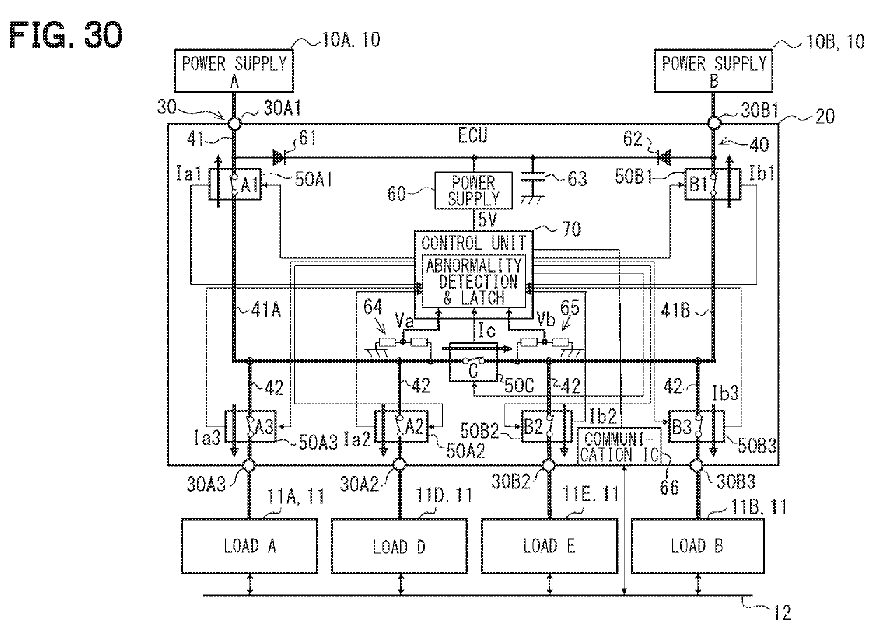

The number of the loads 11 and the arrangement of the loads 11 are not limited to the examples described above. As shown in FIG. 30, it is also possible to adopt a configuration in which the terminals 30A2 and 30B2 are connected to different loads 11. In FIG. 30, the load 11D (load D) is electrically connected to the terminal 30A2, and the load 11E (load E) is electrically connected to the terminal 30B2. As shown in FIG. 30, it is also possible to adopt a configuration in which power is supplied only to the loads 11 that do not have redundancy. It is also possible to adopt a configuration in which no priority is set for power supply among the loads 11.

It is also possible to provide the loads 11 with high priority for power supply. It is also possible to adopt a configuration in which the high-priority loads 11 are connected to the ECU 20 at substantially equivalent positions. It is also possible to provide loads 11 with low-priority for power supply for each of the main lines 41A and 41B. It is also possible to adopt a configuration in which the loads 11 corresponding to each of the main lines 41A and 41B are connected to the ECU 20 at substantially equivalent positions. The load 11 may also have a power distribution function. Electric power may be distributed from the load 11 to lower-level devices.

As shown in FIG. 1, the ECU 20 includes a communication IC 66. As shown in FIG. 6, the control unit 70 (microcontroller 71) is capable of communication via the communication IC 66. Therefore, instead of a configuration that blocks power supply to the lower-priority loads 11A and 11B, an operation restriction request may be transmitted to the loads 11A and 11B to reduce their power consumption. As a result, it is possible to reduce the power consumption of the loads 11A and 11B and secure power supply to the higher-priority load 11C.

As shown in FIGS. 1 and 6, the control unit 70 (microcontroller 71) acquires the values of currents Ia1, Ia2, Ia3, Ib1, Ib2, Ib3, and Ic flowing through each disconnect circuit 50. Therefore, by comparing the currents Ia1, Ia2, and Ia3 on the power supply 10A side with the current Ic, it is possible to perform fault diagnosis of the current detection units 57 of the disconnect circuits 50A1, 50A2, 50A3, and 50C. Specifically, if the total sum of the currents flowing through the terminal disconnect circuits on the power supply 10A side (−Ia1 − Ia3 − Ia2) closely matches the current Ic, it is considered to be normal. Similarly, by comparing the currents Ib1, Ib2, and Ib3 on the power supply 10B side with the current Ic, it is possible to perform fault diagnosis of the current detection units 57 of the disconnect circuits 50B1, 50B2, 50B3, and 50C. Specifically, if the total sum of the currents flowing through the terminal disconnect circuits on the power supply 10B side (Ib1 + Ib3 + Ib2) closely matches the current Ic, it is considered to be normal.

### Second Embodiment

This embodiment is a modification example of a basic aspect of the preceding embodiment, and the description of the preceding embodiment can be incorporated. In the preceding embodiment, power supply to the lower-priority loads 11A and 11B was blocked by means of a hardware configuration. Alternatively, the microcontroller 71 may be used to block the power supply to the lower-priority loads 11A and 11B.

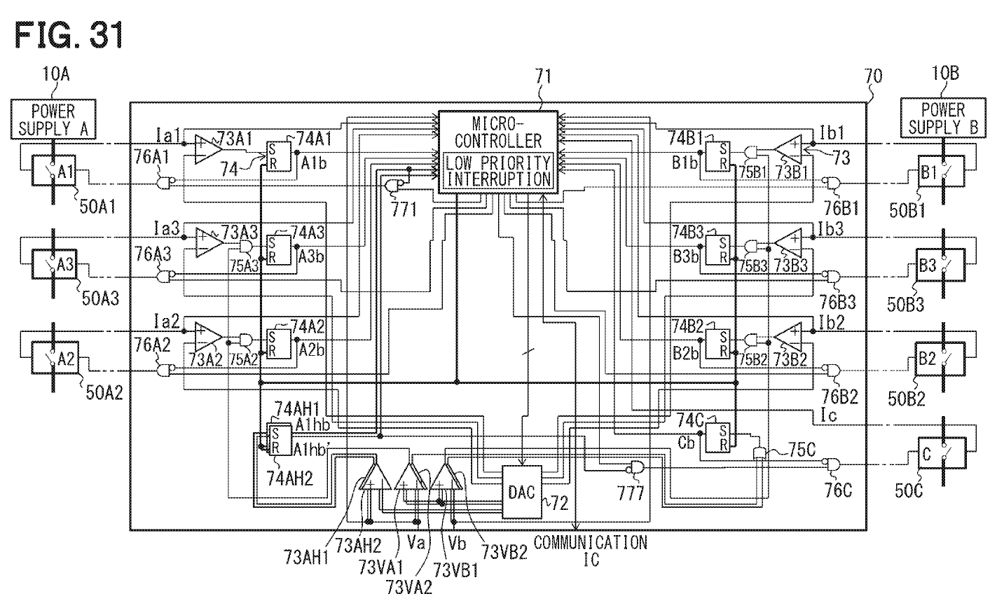

FIG. 31 shows the configuration of the control unit 70 in the ECU 20 according to the present embodiment. The control unit 70 has a configuration in which the gate circuits 772, 773, 774, 775, and 776 have been omitted from the configuration shown in the preceding embodiment (see FIG. 6). The microcontroller 71 has a function (low-priority blocking function) for blocking the lower-priority loads 11A and 11B from power supply. The microcontroller 71 (processor) performs processing equivalent to that of the gate circuits 772 and 773. When an H-level signal is input as the A1b signal and/or A1hb signal to the corresponding INT terminal, the microcontroller 71 outputs an L-level control signal from the PT_A3 terminal. As a result, the gate circuit 76A3 outputs an OFF signal to the disconnect circuit 50A3.

The microcontroller 71 performs processing equivalent to that of the gate circuits 774, 775, and 776. When an H-level signal is input as at least one of the A1b signal, Cb signal, A1hb signal, or A1hb’ signal to the corresponding INT terminal, the microcontroller 71 outputs an L-level control signal from the PT_B3 terminal. As a result, the gate circuit 76B3 outputs an OFF signal to the disconnect circuit 50B3. The other components are the same as those of the ECU 20 described in the preceding embodiment.

### Summary of the Second Embodiment

The ECU 20 of the present embodiment can also achieve effects equivalent to those of the configuration described in the preceding embodiment. Since the microcontroller 71 has a function to block power supply to the low-priority loads 11A and 11B, the circuit configuration of the control unit 70 can be simplified.

### Third Embodiment

This embodiment is a modification example of a basic aspect of the preceding embodiment, and the description of the preceding embodiment can be incorporated. In the preceding embodiment, abnormality detection data is latched by a hardware configuration. The control unit 70 includes an SR latch. Alternatively, the abnormality detection data may be latched by the microcontroller 71.

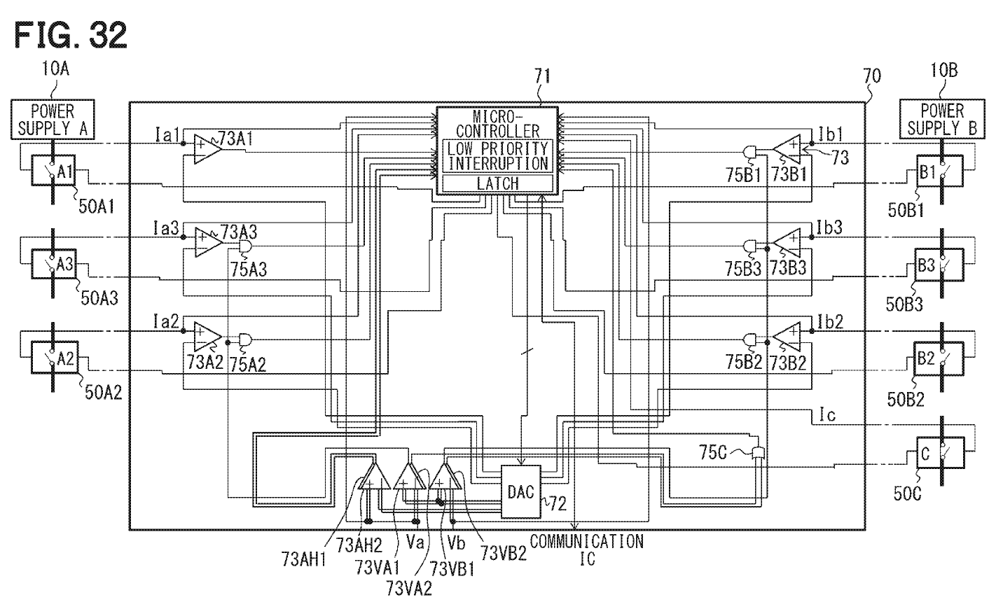

FIG. 32 shows the configuration of the control unit 70 in the ECU 20 according to the present embodiment. The control unit 70 is configured by eliminating all of the latches 74 and the gate circuits 76A1, 76A2, 76A3, 76B1, 76B2, 76B3, 76C, 771, and 777 from the configuration shown in the preceding embodiment (see FIG. 31). The microcontroller 71 has a function (latch function) for retaining abnormality detection data. The microcontroller 71 performs processing equivalent to latches 74A1, 74A2, 74A3, 74AH1, 74AH2, 74B1, 74B2, 74B3, and 74C.The INT terminal of the microcontroller 71 receives the output signals from comparators 73A1, 73AH1, and 73AH2, as well as the output signals from gate circuits 75A2, 75A3, 75B1, 75B2, 75B3, and 75C. The control signal output from the PT terminal of the microcontroller 71 is provided to the drive unit of the corresponding disconnect circuit 50.

Even if a momentary disconnection occurs, the operating voltage of the microcontroller 71 is maintained by the capacitor 63. The microcontroller 71 retains abnormality detection data acquired via the INT terminal. Upon recovery after a power-on reset, a control signal corresponding to the retained abnormality detection data is output. The other components are the same as those of the ECU 20 described in the preceding embodiment.

### Summary of Third Embodiment

The ECU 20 of the present embodiment can also achieve effects equivalent to those of the configuration described in the preceding embodiment. The microcontroller 71, in addition to its power blocking function for low-priority loads 11A and 11B, also has a function for latching abnormality detection data. Therefore, the circuit configuration of the control unit 70 can be further simplified.

### Fourth Embodiment

This embodiment is a modification example of a basic aspect of the preceding embodiment, and the description of the preceding embodiment can be incorporated. In the preceding embodiments, ground faults are detected using the current flowing through each disconnect circuit 50. Alternatively, ground faults may be detected using only the disconnect circuit 50C.

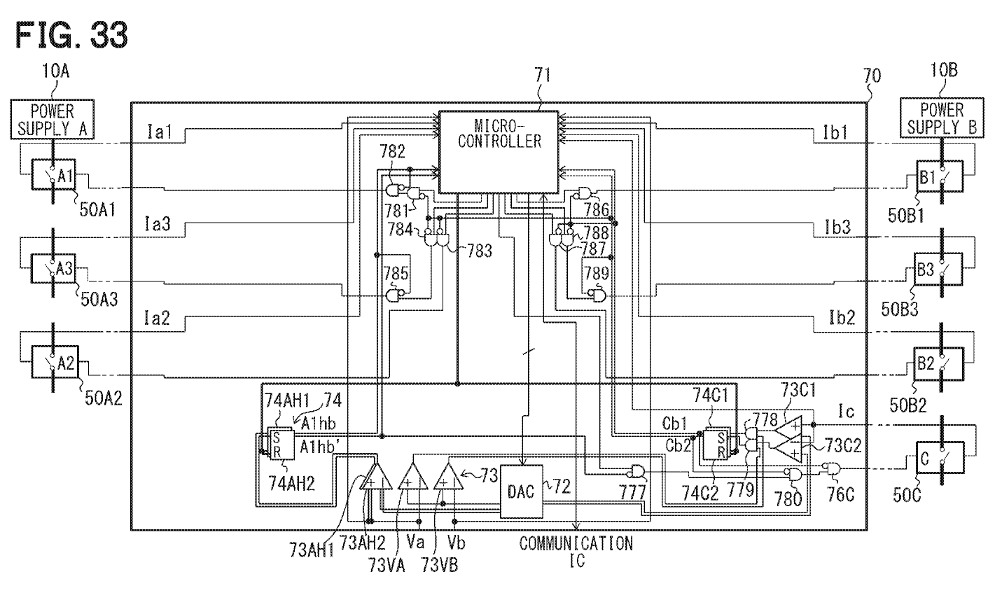

FIG. 33 shows the configuration of the control unit 70 in the ECU 20 according to the present embodiment. The control unit 70 includes a microcontroller 71, a DAC 72, comparators 73, latches 74, and gate circuits. The DAC 72 sets the threshold values for each comparator 73 according to instructions from the microcontroller 71.

The comparators 73 do not include comparators corresponding to the disconnect circuits 50A1, 50A2, 50A3, 50B1, 50B2, and 50B3. The comparators 73 include comparators 73VA and 73VB for detecting voltage drops. The threshold values of the comparators 73VA and 73VB are, for example, a common value. Because ground faults are not detected based on currents Ia1, Ia2, Ia3, Ib1, Ib2, and Ib3, a single comparator 73VA and a single comparator 73VB are included, respectively. The comparator 73VA outputs an H-level signal when the voltage Va falls below the threshold value. The comparator 73VB outputs an H-level signal when the voltage Vb falls below the threshold value. The comparator 73, as in the preceding embodiments, includes overvoltage comparators 73AH1 and 73AH2.

The comparator 73 further includes comparators 73C1 and 73C2. The threshold value is provided to the inverting input terminal of of the comparator 73C1, and the current Ic is provided to the non-inverting input terminal of the comparator 73C1. The current Ic is provided to the inverting input terminal of the comparator 73C2, and the threshold value is provided to the non-inverting input terminal of the comparator 73C2. The comparator 73C1 detects abnormalities in the forward direction, that is, in the direction from the main line 41A to the main line 41B. The comparator 73C1 detects, for example, a ground fault on the main line 41B side. The comparator 73C2 detects abnormalities in the negative direction, that is, in the direction from main line 41B to the main line 41A. The comparator 73C2 detects, for example, a ground fault on the main line 41A side.

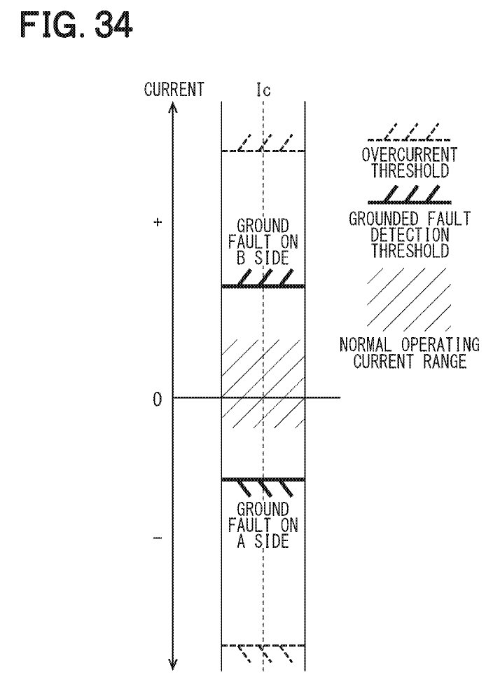

FIG. 34 shows the threshold value. The threshold value of comparator 73C1 is set to a positive (+) value so as to detect a ground fault on the main line 41B side, and is established between the normal operating current range and the positive overcurrent threshold. The threshold value of comparator 73C2 is set to a negative (–) value so as to detect a ground fault on the main line 41A side, and is established between the normal operating current range and the negative overcurrent threshold.

The latch 74 does not include latches corresponding to the disconnect circuits 50A1, 50A2, 50A3, 50B1, 50B2, and 50B3. The latch 74, as in the preceding embodiment, includes latches 74AH1 and 74AH2. The latch 74 further includes latches 74C1 and 74C2. The output signal of the gate circuit 778 is provided to the S terminal of the latch 74C1. The gate circuit 778 is an AND gate, and the output signals of the comparator 73C1 and the comparator 73VB are provided to the gate circuit 778. The latch 74C1 outputs the Cb1 signal. The output signal of the gate circuit 779 is provided to the S terminal of the latch 74C2. The gate circuit 779 is an AND gate, and the output signals of the comparator 73C2 and the comparator 73VA are provided to the gate circuit 779. The latch 74C2 outputs the Cb2 signal.

The microcontroller 71 has four INT terminals. The microcontroller 71 receives the A1hb signal, A1hb’ signal, Cb1 signal, and Cb2 signal as signals indicating interrupt requests.

The gate circuit includes gate circuits 76C, 777 through 789. The gate circuits 76C and 777 through 789 are all AND gates with a NOT gate connected to one of their input terminals.

The control signal output from the PT terminal (PT_C) of the microcontroller 71 is provided to the gate circuit 777, as in the preceding embodiment. The gate circuit 777 receives the control signal and the A1hb’ signal. The output signal from the gate circuit 777 is provided to gate circuit 780. The gate circuit 780 receives the output signal from gate circuit 777 and the inverted Cb2 signal. The output signal from gate circuit 780 is provided to the gate circuit 76C. The gate circuit 76C receives the output signal from gate circuit 780 and the inverted Cb1 signal. That is, when at least one of the following conditions is satisfied: the control signal is at L level; the A1hb’ signal is at H level; the Cb2 signal is at H level; or the Cb1 signal is at H level, the gate circuit 76C outputs an OFF signal to the disconnect circuit 50C.

The control signal output from the PT terminal (PT_A1) of microcontroller 71 is provided to the gate circuit 781. The gate circuit 781 receives the control signal and the inverted Cb2 signal. The output signal of the gate circuit 781 is provided to the gate circuit 782. The gate circuit 782 receives, as inputs, the output signal from gate circuit 781 and the inverted A1hb signal. That is, when at least one of the following conditions is satisfied: the control signal is at L level; the A1hb signal is at H level; or the Cb2 signal is at H level, the gate circuit 782 outputs an OFF signal to the disconnect circuit 50A1.

The control signal output from the PT terminal (PT_A2) of microcontroller 71 is provided to the gate circuit 783. The gate circuit 783 receives the control signal and the inverted Cb2 signal. When the control signal is at L level and/or the Cb2 signal is at H level, the gate circuit 783 outputs an OFF signal to the disconnect circuit 50A2.

The control signal output from the PT terminal (PT_A3) of the microcontroller 71 is provided to the gate circuit 784. The gate circuit 784 receives the control signal and the inverted Cb2 signal. The output signal of the gate circuit 784 is provided to the gate circuit 785. The gate circuit 785 receives the output signal of the gate circuit 784 and the inverted A1hb signal. When at least one of the following conditions is satisfied: the control signal is at L level; the A1hb signal is at H level; or the Cb2 signal is at H level, the gate circuit 785 outputs an OFF signal to the disconnect circuit 50A3.

The control signal output from the PT terminal (PT_B1) of the microcontroller 71 is provided to the gate circuit 786. The gate circuit 786 receives the control signal and the inverted Cb1 signal. When the control signal is at L level and/or the Cb1 signal is at H level, the gate circuit 786 outputs an OFF signal to the disconnect circuit 50B1.

The control signal output from the PT terminal (PT_B2) of the microcontroller 71 is provided to the gate circuit 787. The gate circuit 787 receives the control signal and the inverted Cb1 signal. When the control signal is at L level and/or the Cb1 signal is at H level, the gate circuit 787 outputs an OFF signal to the disconnect circuit 50B2.

The control signal output from the PT terminal (PT_B3) of the microcontroller 71 is provided to the gate circuit 788. The gate circuit 788 receives the control signal and the inverted Cb1 signal. The output signal of the gate circuit 788 is provided to the gate circuit 789. The gate circuit 789 receives the output signal from gate circuit 788 and the inverted Cb2 signal. When at least one of the following conditions is met: the control signal is at L level; the Cb1 signal is at H level; or the Cb2 signal is at H level, the gate circuit 789 outputs an OFF signal to the disconnect circuit 50A3. Since the gate circuit 789 outputs an OFF signal when, for example, the Cb2 signal is at H level, it is possible to block power supply to the lower-priority load 11B in the event of a ground fault occurring on the main line 41A side. The other components are the same as those of the ECU 20 described in the preceding embodiment.

### Summary of Fourth Embodiment

The ECU 20 of the present embodiment can also achieve effects equivalent to those of the configuration described in the preceding embodiment. In the present embodiment, the control unit 70 outputs an OFF signal to the disconnect circuit 50C when at least one of the voltages Va or Vb falls below a predetermined threshold voltage and the current Ic exceeds a predetermined threshold current. Since ground fault detection can be performed solely by the disconnect circuit 50C, the circuit configuration can be simplified.

### Modified Example

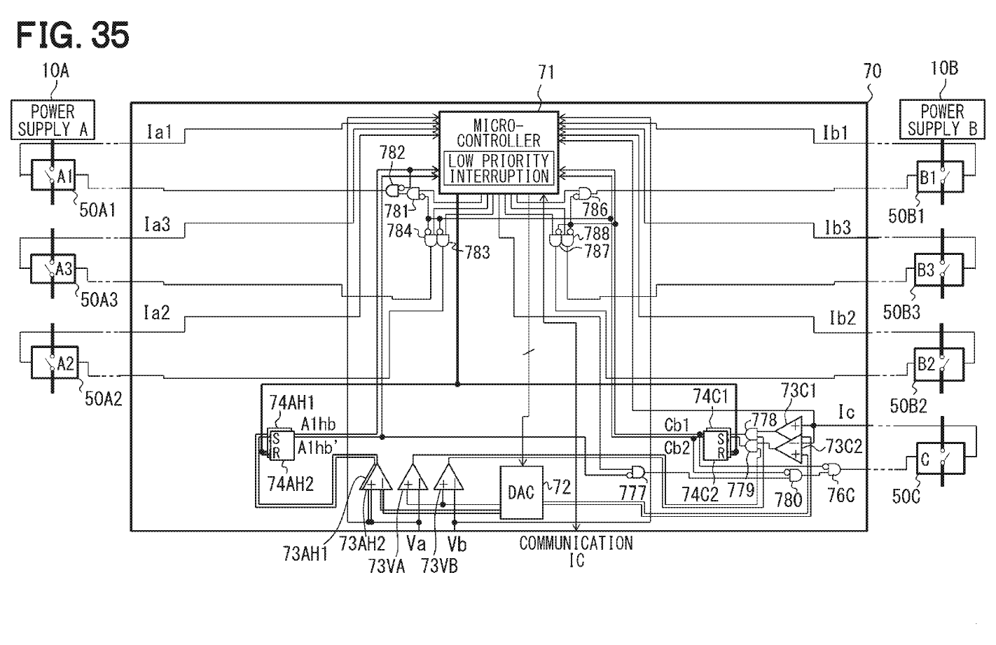

As shown in FIG. 35, the microcontroller 71 may be provided with a function to block power supply to loads with low priority. The control unit 70 shown in FIG. 35 has a configuration in which the gate circuits 785 and 789 shown in FIG. 33 have been eliminated. The microcontroller 71 has a function to block the low-priority loads 11A and 11B. The microcontroller 71 (processor) executes processing equivalent to the gate circuit 785. When an H-level signal is provided as the A1hb signal, the microcontroller 71 outputs an L-level control signal from the PT_A3 terminal. The gate circuit 784 outputs an OFF signal to the disconnect circuit 50A3. The microcontroller 71 executes processing equivalent to the gate circuit 789. When an H-level signal is provided as the Cb2 signal, the microcontroller 71 outputs an L-level control signal from the PT_B3 terminal. The gate circuit 788 outputs an OFF signal to the disconnect circuit 50B3.

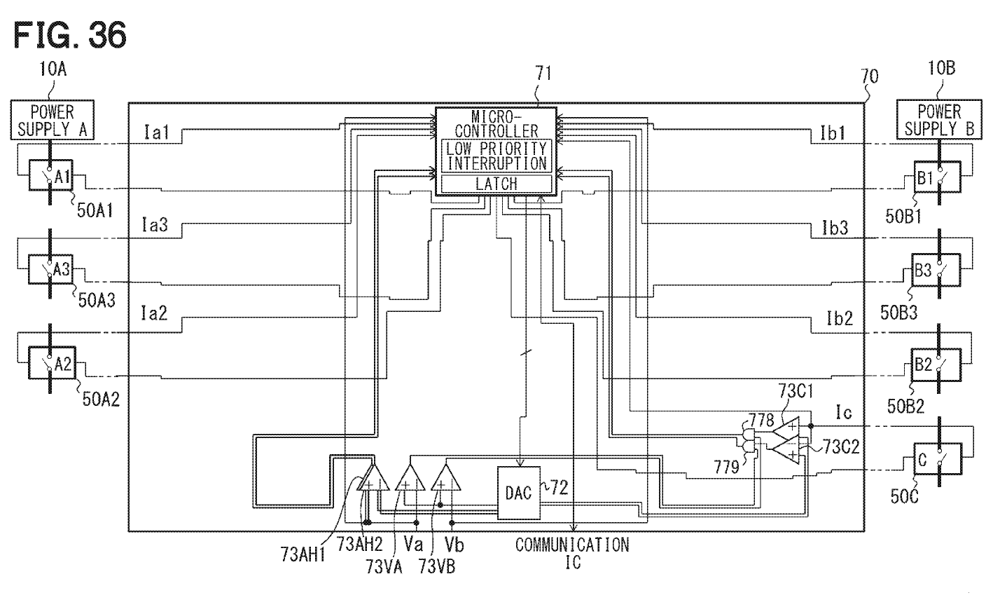

As shown in FIG. 36, the microcontroller 71 may be provided with a function to latch abnormality detection data. The control unit 70 shown in FIG. 36 is configured by eliminating all the latches 74 and the gate circuits 76C, 777, and 780 to 787 from the configuration shown in FIG. 35. The microcontroller 71 has a function to retain abnormality detection data. The microcontroller 71 performs processing equivalent to that of latches 74AH1, 74AH2, 74C1, and 74C2. The INT terminal of the microcontroller 71 receives the output signals from the comparators 73AH1 and 73AH2, as well as the output signals from the gate circuits 778 and 789. The control signal output from the PT terminal of the microcontroller 71 is provided to the drive unit of the corresponding disconnect circuit 50.

Even if a momentary disconnection occurs, the operating voltage of the microcontroller 71 is maintained by the capacitor 63. The microcontroller 71 retains the abnormality detection data from before the momentary disconnection. Upon recovery after a power-on reset, the microcontroller 71 outputs a control signal corresponding to the abnormality detection data it has retained.

### Fifth Embodiment

This embodiment is a modification example of a basic aspect of the preceding embodiment, and the description of the preceding embodiment can be incorporated. In the preceding embodiments, power is supplied to a single ECU 20 from the power supplies 10. Alternatively, it is also possible to adopt a configuration in which power is supplied from the power supplies 10 to the ECUs 20 connected in a ring.

### Power Supply System

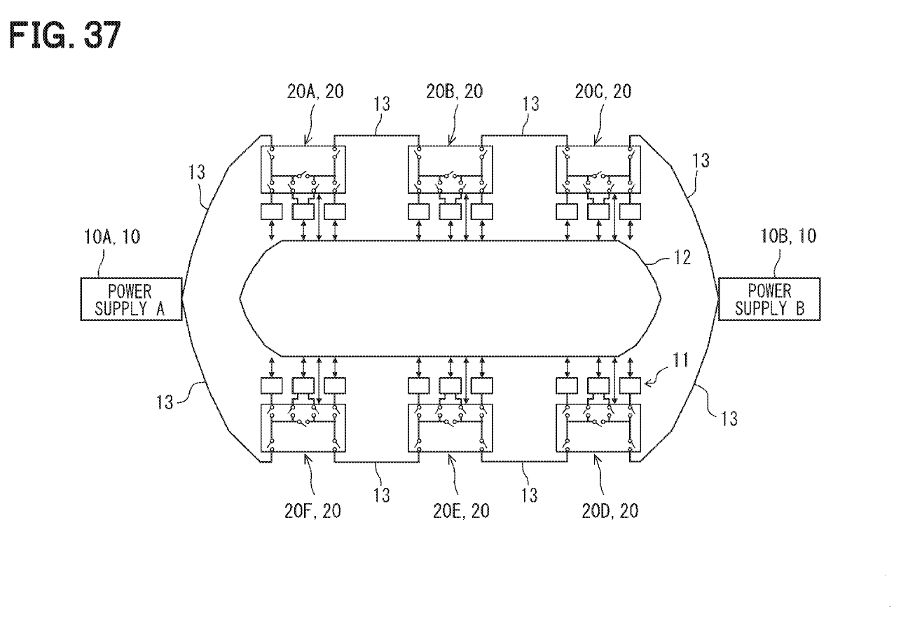

FIG. 37 shows an example of a power supply system. The power supply system includes the power supplies 10 and the ECUs 20. For example, the power supply 10 according to the present embodiment includes a power supply 10A and a power supply 10B, similarly to the preceding embodiment.

Each of the ECUs 20, similarly to the preceding embodiment, receives power supply from the power supplies 10 and distributes power to the loads 11. For example, the ECUs 20 according to the present embodiment include six ECUs: 20A, 20B, 20C, 20D, 20E, and 20F. The number and functions of the loads 11 to be connected may differ depending on each ECU 20. The loads 11 connected to each ECU 20 may include, as in the preceding embodiment, loads with high priority and loads with low priority for power supply. Only some of the ECUs 20 may include, among the connected loads 11, both loads with high priority and loads with low priority. For convenience, in FIG. 37, the configuration of each ECU 20 is made common, and the number of loads 11 connected to each ECU 20 is set to three. The arrangement of the terminals 30, the power wiring 40, and the disconnect circuits 50 in the ECU 20 is the same as the configuration shown in the preceding embodiment (see, for example, FIG. 1). The ECU 20 includes the capacitor 63.

The ECUs 20 are connected in a ring configuration via the power supply line 13. In the example shown in FIG. 37, the ECU 20A, ECU 20B, ECU 20C, ECU 20D, ECU 20E, and ECU 20F are arranged in that order. In the ring configuration, for example, the ECU 20B and the ECU 20F are arranged adjacent to the ECU 20A. Adjacent to the ECU 20C, the ECU 20B and the ECU 20D are arranged. The power supply 10A is connected to the power supply line 13 that connects the ECU 20A to the ECU 20F. The power supply 10B is connected to the power supply line 13 that connects the ECU 20C to the ECU 20D.

For example, the ECU 20A is supplied with power from the power supply 10A via the power supply line 13, and is also supplied with power from the power supply 10B via the power supply line 13 and through the ECU 20B and the ECU 20C. The ECU 20F is supplied with power from the power supply 10A via the power supply line 13, and is also supplied with power from the power supply 10B via the power supply line 13 and through the ECU 20D and the ECU 20E. The ECU 20B is supplied with power from the power supply 10A via the power supply line 13 and through the ECU 20A, and is also supplied with power from the power supply 10B via the power supply line 13 and through the ECU 20C.

The ECUs 20 are capable of communicating with each other via the communication bus 12. For example, in this embodiment, adjacent ECUs 20 share a portion of the information acquired from the INT terminal. Similar to the preceding embodiment, the load 11 is capable of communicating with other devices, other loads 11, and ECUs 20 not intended for connection via the communication bus 12.

### Control Unit

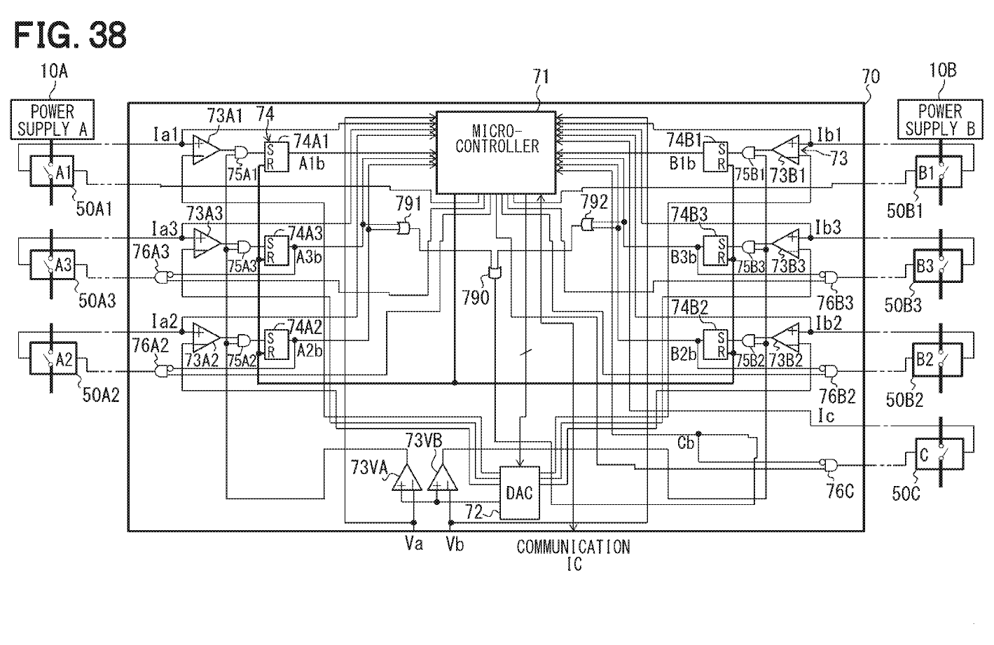

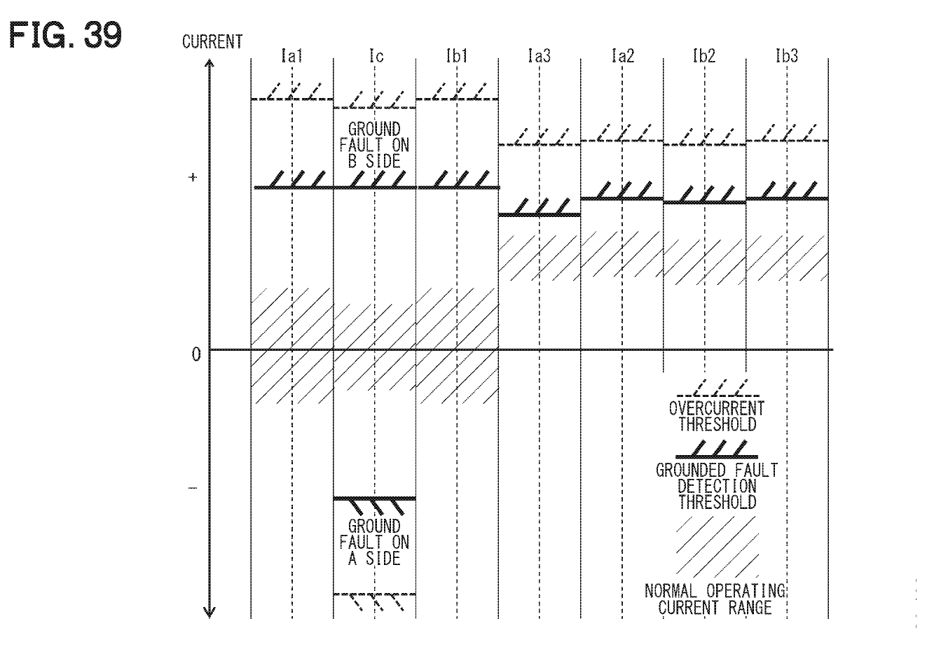

FIG. 38 shows the configuration of the control unit 70 in the ECU 20 according to the present embodiment. FIG. 39 shows the threshold value. The control unit 70 includes a microcontroller 71, a DAC 72, comparators 73, latches 74, and gate circuits.

The comparators 73 are configured by excluding the comparators 73AH1, 73AH2, 73VA1, 73VA2, 73VB1, and 73VB2 shown in the preceding embodiment (see FIG. 6) and by adding the comparators 73VA and 73VB. The comparators 73 include the comparators 73A1, 73A2, 73A3, 73B1, 73B2, 73B3, 73VA, and 73VB. The threshold values of the comparators 73VA and 73VB are, for example, a common value.

FIG. 39 shows an example of the threshold values to be set. In FIG. 39, as in FIG. 8, the threshold for ground fault detection, the overcurrent threshold, and the normal operating current range are shown. The forward direction and reverse direction are the same as in the preceding embodiment. Due to the ring-shaped connection, during normal operation, currents Ia1 and Ib1 can flow in both the positive and negative directions. The ground fault detection threshold for currents Ia1 and Ib1 is a positive (+) value, and is set between the normal operating current range and the overcurrent threshold. The ground fault detection thresholds for currents Ia1 and Ib1 and the ground fault detection threshold on the B side for current Ic are approximately equal in value.

The latch 74 is configured so that the latches 74AH1, 74AH2, and 74C are eliminated from the configuration shown in the preceding embodiment (see FIG. 6). The latch 74 includes latches 74A1, 74A2, 74A3, 74B1, 74B2, and 74B3.

The gate circuit is configured by eliminating the gate circuits 75C, 76A1, 76B1, and 771 to 777 from the configuration shown in the preceding embodiment (see FIG. 6), and by adding gate circuits 790, 791, and 792. The gate circuits 790, 791, and 792 are all OR gates. The gate circuit 790 outputs the Cb signal. The Cb signal is provided to the gate circuit 76C and the INT terminal of the microcontroller 71. The output signals of the gate circuits 791 and 792 are provided to the gate circuit 790. The A2b signal output from the latch 74A2 and the A3b signal output from the latch 74A3 are provided to the gate circuit 791. The B2b signal output from the latch 74B2 and the B3b signal output from the latch 74B3 are provided to the gate circuit 792. The other components are the same as those of the ECU 20 described in the preceding embodiment.

### Disconnection Conditions

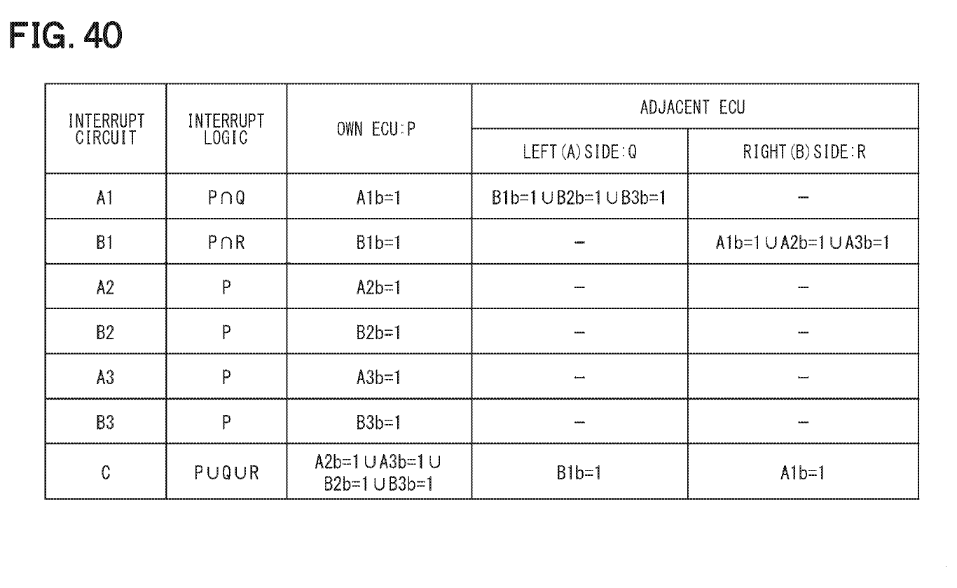

FIG. 40 shows the disconnection conditions of the disconnect circuit 50 by the microcontroller 71. The microcontroller 71, or the control unit 70, disconnects (turns off) the corresponding disconnect circuit 50 in accordance with the disconnection logic shown in FIG. 40. Based on the ground fault detection (latch) information from the INT terminal and the ground fault detection (latch) information obtained via communication from the adjacent ECU 20, the microcontroller 71 outputs an L-level control signal to the disconnect circuits 50A1, 50B1, and 50C arranged on the main line 41, thereby disconnecting them. The disconnect circuits 50A2, 50A3, 50B2, and 50B3 are disconnected hardware-wise by the ground fault detection (latch) circuit. As described above, “1” for each signal corresponds to the H level.

A control signal output from the PT terminal (PT_A1) of the microcontroller is provided to the interruption circuit 50A1. The microcontroller 71 outputs an L-level signal as a control signal when the A1b signal input from the INT terminal is “1” and at least one of the B1b signal, B2b signal, or B3b signal acquired from the adjacent ECU 20 on the left is “1”. In other words, when, in the local ECU 20, the voltage Va drops and the current Ia1 exceeds the threshold, and/or, in the adjacent ECU 20 on the left, the voltage Vb drops and at least one of the currents Ib1, Ib2, or Ib3 exceeds the threshold, the microcontroller 71 outputs an off signal to the disconnect circuit 50A1.

The output signal of the gate circuit 76A2 is provided to the disconnect circuit 50A2. The gate circuit 76A2 receives a control signal output from the PT terminal (PT_A2) of the microcontroller 71 and an inverted A2b signal. The gate circuit 76A2 outputs an OFF signal to the disconnect circuit 50A2 when the control signal is at L level and/or the A2b signal output from the latch 74A2 is at H level.

The output signal of the gate circuit 76A3 is provided to the disconnect circuit 50A3. The gate circuit 76A3 receives a control signal output from the PT terminal (PT_A3) of the microcontroller 71 and an inverted A3b signal. The gate circuit 76A3 outputs an OFF signal to the disconnect circuit 50A3 when the control signal is at L level and/or the A3b signal output from the latch 74A3 is at H level.

The disconnect circuit 50B1 receives a control signal output from the PT terminal (PT_B1) of the microcontroller. The microcontroller 71 outputs an L-level signal as a control signal when the B1b signal provided from the INT terminal is “1” and at least one of the A1b, A2b, or A3b signals acquired from the adjacent ECU 20 on the right is “1.” That is, in the present ECU 20, when the voltage Vb drops and the current Ib1 exceeds the threshold, and/or in the adjacent ECU 20 on the right, when the voltage Va drops and at least one of the currents Ia1, Ia2, or Ia3 exceeds the threshold, the microcontroller 71 outputs an off signal to the disconnect circuit 50B1.

The output signal of the gate circuit 76B2 is provided to the disconnect circuit 50B2. The gate circuit 76B2 receives the control signal output from the PT terminal (PT_B2) of the microcontroller 71 and a signal obtained by inverting the B2b signal. The gate circuit 76B2 outputs an OFF signal to the interruption circuit 50B2 when the control signal is at L level and/or the B2b signal output from the latch 74B2 is at H level.

The output signal of the gate circuit 76B3 is provided to the disconnect circuit 50B3. The gate circuit 76B3 receives the control signal output from the PT terminal (PT_B3) of the microcontroller 71 and a signal obtained by inverting the B3b signal. The gate circuit 76B3 outputs an OFF signal to the disconnect circuit 50B3 when the control signal is at L level and/or the B3b signal output from the latch 74B3 is at H level.

The output signal of the gate circuit 76C is provided to the disconnect circuit 50C. The gate circuit 76C receives the control signal output from the PT terminal (PT_C) of the microcontroller 71 and the Cb signal output from the gate circuit 790. The microcontroller 71 outputs an L-level signal as a control signal when at least one of the following conditions is satisfied: at least one of the A2b signal, A3b signal, B2b signal, or B3b signal input from the INT terminal is 1; the B1b signal acquired from the ECU 20 on the left is 1; or the A1b signal acquired from the ECU 20 on the right is 1. The gate circuit 76C outputs an OFF signal to the disconnect circuit 50C when the control signal is at L level and/or the Cb signal output from the gate circuit 790 is at H level.

### Operation Example in the Event of Ground Fault

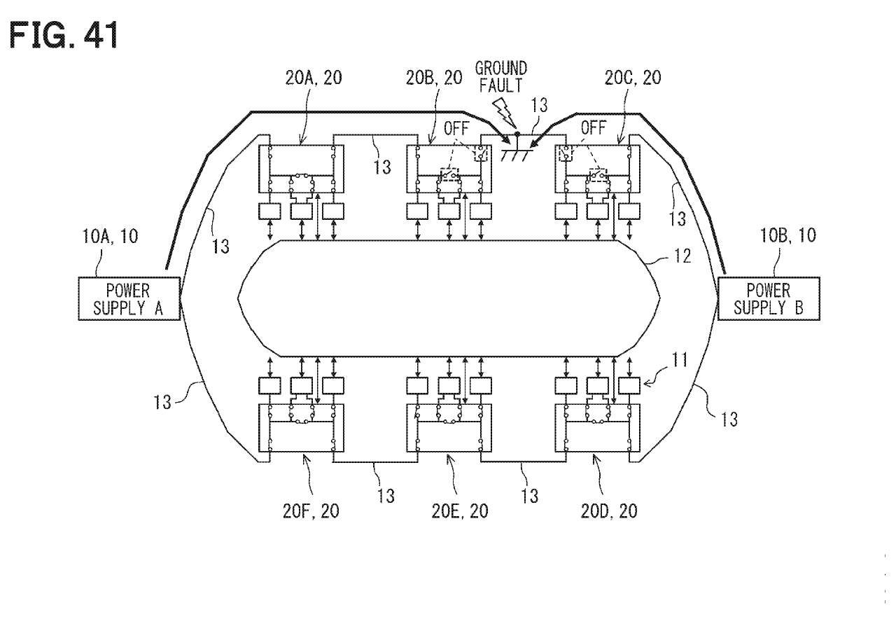

FIG. 41 shows an example of the operation when a ground fault occurs in the power supply line 13 that connects the ECU 20B to the ECU 20C. In other words, FIG. 41 shows an example of the operation when a ground fault occurs between the terminal 30B1 of the ECU 20B and the terminal 30A1 of the ECU 20C.

As indicated by the solid arrows, current flows from the power supplies 10A and 10B into the ground fault location. In the ECU 20B, the divided voltage value Vb corresponding to the main line 41B on the ground fault side decreases, and the current Ib1 flowing through the disconnect circuit 50B1 closest to the ground fault location exceeds the threshold value, so the B1b signal goes to the H level. Additionally, in the ECU 20C, the divided voltage value Va corresponding to the main line 41A on the ground fault side decreases, and the current Ia1 flowing through the disconnect circuit 50A1 closest to the ground fault location exceeds the threshold value, so the A1b signal becomes 1 (H level). The microcontroller 71 of ECU 20B outputs an L-level control signal to the disconnect circuit 50B1 because the B1b signal of ECU 20B is 1 and the A1b signal of the adjacent ECU 20C, obtained via communication, is also 1. The microcontroller 71 of ECU 20B outputs an L-level control signal to the disconnect circuit 50C because the A1b signal of the adjacent ECU 20C is 1.

Similarly, the microcontroller 71 of ECU 20C outputs an L-level control signal to the disconnect circuit 50A1 because the A1b signal of ECU 20C is 1 and the B1b signal of the adjacent ECU 20B, obtained via communication, is also 1. The microcontroller 71 of ECU 20C outputs an L-level control signal to the disconnect circuit 50C because the B1b signal of the adjacent ECU 20B is 1.

As a result, as shown in FIG. 41, the disconnect circuits 50B1 and 50C of ECU 20B, and the disconnect circuits 50A1 and 50C of ECU 20C are turned off. Therefore, power can be supplied from the power supply 10A to the loads 11A and 11C of ECU 20B. It is possible to supply power from the power supply 10B to the loads 11A and 11C of ECU 20B via the route passing through the ECUs 20D, 20E, and 20F. In addition, power can be supplied from the power supply 10B to the loads 11B and 11C of the ECU 20B. Power can be supplied from the power supply 10A to the loads 11B and 11C of the ECU 20C via the route passing through the ECU 20F, 20E, and 20D. Even if the disconnect circuit 50C is turned off, power supply to the load 11C, which has a high priority for power supply, can be maintained. Furthermore, by turning off the disconnect circuits 50C of both the ECUs 20B and 20C, even if a fault such as a short circuit occurs in the disconnect circuit 50A1 of ECU 20C and it cannot be turned off, power supply to the high-priority load 11C can still be maintained.

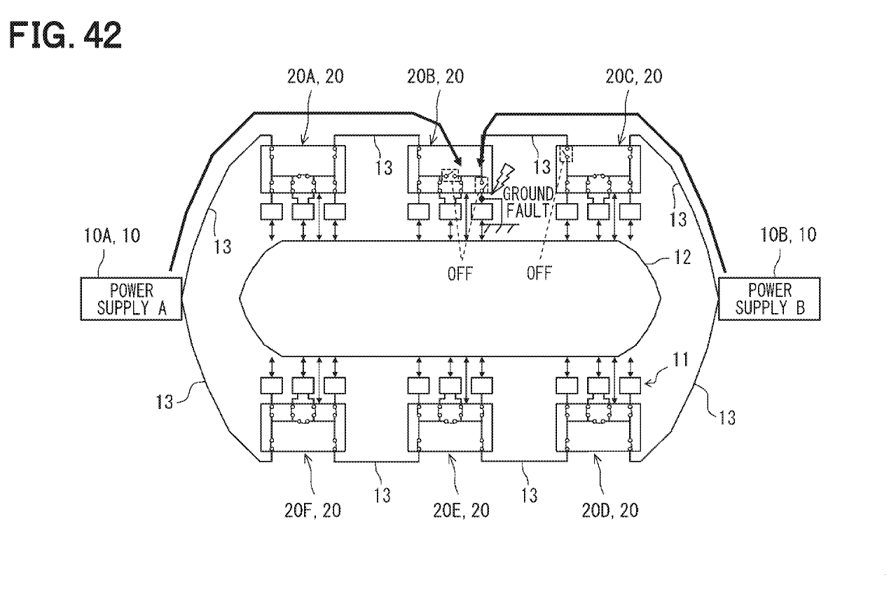

FIG. 42 illustrates an example of the operation when a ground fault occurs at the terminal 30B3 of the ECU 20B. In other words, it shows an example of the operation when a ground fault occurs in the power supply line that connects the terminal 30B3 of the ECU 20B to the load 11B.

As indicated by the solid arrows, current flows from the power supplies 10A and 10B into the ground fault location. In the ECU 20B, the divided voltage value Vb corresponding to the voltage of the main line 41B on the ground fault side decreases, and the current Ib3 flowing through the disconnect circuit 50B3 closest to the ground fault location exceeds the threshold value, so the B3b signal becomes 1. Furthermore, the gate circuit 76B3 and the gate circuits 792, 790, and 76C output L-level control signals to the disconnect circuits 50B3 and 50C. Therefore, power can be supplied from the power supply 10A to the loads 11A and 11C of ECU 20B. It is possible to supply power from the power supply 10B to the loads 11A and 11C of ECU 20B via the route passing through the ECUs 20D, 20E, and 20F. Even if the disconnect circuit 50C is turned off, power supply to the load 11C, which has a high priority for power supply, can be maintained.

Additionally, since the microcontroller 71 of the ECU 20C has obtained, via communication, that the B3b signal of the adjacent ECU 20B on the left is 1, it outputs an L-level control signal to the disconnect circuit 50A1. Therefore, it is possible to supply power from the power supply 10B to each load 11 (11A, 11B, 11C) of the ECU 20B. It is possible to supply power from the power supply 10A to each load 11 of the ECU 20C via the route passing through the ECUs 20F, 20E, and 20D. Furthermore, even if a fault such as a short circuit occurs in the disconnect circuit 50B3 of the ECU 20B or the disconnect circuit 50A1 of the ECU 20C, making it impossible to turn off due to a fault, power supply to the load 11C of the ECU 20B, which has a high priority, can still be maintained by turning off the disconnect circuit 50C of the ECU 20B.

As shown in the preceding embodiment, the disconnect circuits 50A1, 50A2, 50A3, 50B1, 50B2, and 50B3 corresponding to terminal 30 may be turned off first, and then the disconnect circuit 50C may be turned off subsequently. After the disconnect circuit 50C is turned off, if the voltage exceeds the threshold value, the disconnect circuit 50C may be turned back on.

### Summary of the Fifth Embodiment

The ECU 20 of the present embodiment can also achieve effects equivalent to those of the configuration described in the preceding embodiment.

### Other Embodiments

The disclosure in this specification and drawings is not limited to the illustrated embodiments. The disclosure encompasses the illustrated embodiments as well as modifications thereof made by those skilled in the art based on these embodiments. For example, the disclosure is not limited to the combinations of components and/or elements shown in the embodiments. The disclosure can be implemented in various combinations. The disclosure may include additional parts that can be added to the embodiments. The disclosure includes cases where components and/or elements of the embodiments are omitted. The disclosure encompasses replacement or combination of components and/or elements between one embodiment and another embodiment. The technical scope disclosed is not limited to the descriptions of the embodiments. Some aspects of the technical scope disclosed are indicated by the descriptions in the present disclosure and should be understood to include all modifications within the meaning and scope of equivalence to the descriptions in the present disclosure.

The disclosure in the specification and drawings is not limited by the descriptions in the present disclosure. The disclosure in the specification and drawings encompasses the technical concepts described in the claims, and furthermore extends to more diverse and broader technical concepts than those recited in the present disclosure. Therefore, regardless of the limitations of the descriptions in the present disclosure, various technical concepts can be extracted from the disclosure in the specification and drawings.

When an element or layer is referred to as being “on,” “connected to,” “attached to,” or “joined to” another element or layer, it may be directly on, connected to, attached to, or joined to the other element or layer, or there may be intervening elements or layers present. In contrast, when an element is referred to as being “directly on,” “directly connected to,” “directly attached to,” or “directly joined to” another element or layer, no intervening elements or layers are present. Other terms used to describe relationships between elements should be interpreted in a similar manner (for example, “between” versus “directly between,” “adjacent to” versus “directly adjacent to,” and so forth). As used in this specification, the term “and/or” includes any and all combinations of the related listed items, as well as any one of the items. That is, the phrase “A and/or B” means at least one of A and B.

Spatially relative terms such as “inner,” “outer,” “back,” “below,” “lower,” “upper,” “higher,” and the like are used herein to facilitate the description of the relationship of one element or feature to another element or feature as illustrated. Spatially relative terms may be intended to encompass orientations other than those depicted in the drawings, including different orientations of the apparatus during use or operation. For example, if the apparatus in the figures is turned over, an element described as “below” or “directly below” another element or feature would be oriented “above” the other element or feature. Therefore, the term “below” may encompass both upward and downward orientations. The apparatus may be oriented in other directions (rotated 90 degrees or to other orientations), and the spatially relative descriptors used herein are to be interpreted accordingly.

An example of a CPU included in the microcontroller 71 has been described as the processor, but the invention is not limited thereto. An MPU, GPU, DFP, or the like may also be employed. MPU is an abbreviation for Micro-Processing Unit. GPU is an abbreviation for Graphics Processing Unit. DFP is an abbreviation for Data Flow Processor. Alternatively, an SoC may be used in place of the microcontroller 71. SoC is an abbreviation for System on Chip. An ASIC or FPGA, among others, may also be used. ASIC is an abbreviation for Application Specific Integrated Circuit. FPGA is an abbreviation for Field-Programmable Gate Array.

The control program may be stored on a non-transitory tangible storage medium as instructions executable by a computer. As storage media for the control program, devices such as HDDs, SSDs, and flash memory may be used. HDD is an abbreviation for Hard-disk Drive. SSD is an abbreviation for Solid State Drive.

What is claimed is:

1. An electronic control unit configured to receive power from power supplies and distribute the power to loads, the electronic control unit comprising:
terminals including
power terminals electrically connected to the power supplies, and
load terminals electrically connected to the loads;
a power wiring including
a main line that electrically connects a first power terminal to a second power terminal, the first power terminal being one of the power terminals, the second power terminal being another of the power terminals, and
branch lines that electrically connect the main line to the load terminals;
disconnect circuits respectively located at the main line and the branch lines, each disconnect circuit configured to
conduct a current supplied from a respective one of the power supplies in a connection state, and
cut off the current supplied from the respective one of the power supplies in a disconnection state; and
a controller configured to control the disconnect circuits to selectively switch between the connection state and the disconnection state, wherein
the disconnect circuits include:
a main-line disconnect circuit located at the main line; and
terminal disconnect circuits correspondingly provided for the terminals,
the main line includes:
a first main-line section extending between the main-line disconnect circuit and the first power terminal; and
a second main-line section extending between the main-line disconnect circuit and the second power terminal,
the terminal disconnect circuits include:
load disconnect circuits correspondingly located at the branch lines, each branch line connected to a respective one of the load terminals;
a first power disconnect circuit located at a portion of the first main-line section that extends between the first power terminal and junction nodes at which the branch lines are connected to the first main-line section; and
a second power disconnect circuit located at a portion of the second main-line section that extends between the second power terminal and the junction nodes at which the branch lines are connected to the second main-line section, and
the controller is configured to control the main-line disconnect circuit and at least one of the terminal disconnect circuits to the disconnection state, on condition that at least one of (i) a current flowing through the at least one of the terminal disconnect circuits or (ii) a voltage of the power wiring satisfies a predetermined abnormality detection condition.

2. The electronic control unit according to claim 1, wherein
the loads include a first load and a second load,
the second load has a lower priority to receive power than the first load, and
the first load is connected to a first load terminal and a second load terminal, the first load terminal being one of the load terminals and electrically connected to the first main-line section, the second load terminal being another of the load terminals and electrically connected to the second main-line section.

3. The electronic control unit according to claim 2, wherein
the second load is one of second loads,
the load disconnect circuits include second load disconnect circuits correspondingly provided for the second loads, and
the controller is configured to control at least one of the second load disconnect circuits to the disconnection state, upon controlling the main-line disconnect circuit to the disconnection state or controlling the first power disconnect circuit to the disconnection state.

4. The electronic control unit according to claim 2, wherein
the second load is one of second loads,
the controller is configured to transmit an operation restriction request to at least one of the second loads to reduce power consumption, upon controlling the main-line disconnect circuit to the disconnection state or controlling the first power disconnect circuit to the disconnection state.

5. The electronic control unit according to claim 1, wherein
a first voltage is a voltage of the first main-line section,
a second voltage is a voltage of the second main-line section,
the controller is configured to control the main-line disconnect circuit to the disconnection state, on condition that at least one of the first voltage or the second voltage falls below a predetermined threshold voltage.

6. The electronic control unit according to claim 1, wherein
a first voltage is a voltage of the first main-line section,
a second voltage is a voltage of the second main-line section,
a main-line current is a current flowing through the main-line disconnect circuit, and
the controller is configured to control the main-line disconnect circuit to the disconnection state, on condition that both conditions are satisfied:
at least one of the first voltage or the second voltage falls below the predetermined threshold voltage; and
the main-line current exceeds a predetermined threshold current.

7. The electronic control unit according to claim 5, wherein
the controller is configured to control a corresponding terminal disconnect circuit of the terminal disconnect circuits to the disconnection state, on condition that both conditions are satisfied:
at least one of the first voltage or the second voltage falls below the predetermined threshold voltage, and
a current flowing through the corresponding terminal disconnect circuit exceeds a predetermined threshold current.

8. The electronic control unit according to claim 7, wherein
a predetermined disconnect threshold voltage of the main-line disconnect circuit, at which the main-line disconnect circuit is controlled to be the disconnection state, is lower than a predetermined disconnect threshold voltage of each of the terminal disconnect circuits, at which the terminal disconnect circuits are controlled to be the disconnection state.

9. The electronic control unit according to claim 5, wherein
the controller is configured to, after controlling the main-line disconnect circuit to the disconnection state, control the main-line disconnect circuit to the connection state in response to the first voltage and the second voltage becoming greater than or equal to the predetermined threshold voltage.

10. The electronic control unit according to claim 1, further comprising:
a capacitor connected to a power supply path extending between each of the power supplies and the controller, wherein
the controller is configured to retain data correlated to satisfying of the predetermined abnormality detection condition.

11. The electronic control unit according to claim 1, wherein
the power supplies include a first power supply and a second power supply,
the first power supply is connected to the first power terminal,
the second power supply is connected to the second power terminal, and
the first power supply has a higher capacity to supply power than the second power supply.

12. The electronic control unit according to claim 11, wherein
a value of the current flowing through the first power disconnect circuit is positive when a current flows from the first power disconnect circuit to the first power terminal, and
the controller is configured to control the first power disconnect circuit to the disconnection state, on condition that the value of the current flowing through the first power disconnect circuit is positive or zero.

13. The electronic control unit according to claim 11, wherein
the controller is configured to control the first power disconnect circuit and the main-line disconnect circuit to the disconnection state, on condition that a voltage of the first main-line section exceeds an overvoltage threshold.

14. The electronic control unit according to claim 13, wherein
an overvoltage disconnect threshold of the main-line disconnect circuit, at which the main-line disconnect circuit is controlled to be the disconnection state,, is higher than an overvoltage disconnect threshold of the first power disconnect circuit, at which the first power disconnect circuit is controlled to be the disconnection state

15. The electronic control unit according to claim 1, wherein
the controller is configured to execute fault diagnosis of the disconnect circuits based on the current flowing through the main-line disconnect circuit and the current flowing through each of the terminal disconnect circuits.
